(19) United States
(12) Patent Application Publication
(10) Pub. No.: US 2018/0048008 A1
(43) Pub. Date: Feb. 15, 2018

(54) Porous Electrodes, Membrane-Electrode Assemblies, Electrode Assemblies, and Electrochemical Cells and Liquid Flow Batteries Therefrom

(71) Applicant: 3M INNOVATIVE PROPERTIES COMPANY, St. Paul, MN (US)

(72) Inventors: Raymond P. Johnston, Lake Elmo, MN (US); Onur S. Yordem, St. Paul, MN (US); Brett J. Sitter, Cottage Grove, MN (US); Bradley W. Eaton, Woodbury, MN (US); Brian T. Weber, St. Paul, MN (US); Gregory M. Haugen, Edina, MN (US); Bharat R. Acharya, Woodbury, MN (US); Brandon A. Bartling, Woodbury, MN (US)

(21) Appl. No.: 15/557,168

(22) PCT Filed: Mar. 22, 2016
(86) PCT No.: PCT/US2016/023573

§ 371 Date: Sep. 11, 2017

Related U.S. Application Data
(60) Provisional application No. 62/137,563, filed on Mar. 24, 2015.
(60) Provisional application No. 62/269,227, filed on Dec. 18, 2015.

(51) Int. Cl. H01M 8/1004; H01M 4/86; H01M 8/18

(52) U.S. Cl. CPC H01M 8/1004; H01M 8/188; H01M 4/8605; H01M 4/8673; H01M 2004/021

(57) ABSTRACT

The present disclosure relates to porous electrodes, membrane-electrode assemblies, electrode assemblies and electrochemical cells and liquid flow batteries produced therefrom. The disclosure further provides methods of making electrodes, membrane-electrode assemblies and electrode assemblies. The porous electrodes include polymer, e.g. non-electrically conductive polymer particulate fiber, and an electrically conductive carbon particulate. The non-electrically conductive, polymer particulate fibers may be in the form of a first porous substrate, wherein the first porous substrate is at least one of a woven or nonwoven paper, felt, mat and cloth. Membrane-electrode assemblies and electrode assemblies may be produced from the porous electrodes of the present disclosure. Electrochemical cells and liquid flow batteries may be produced from the porous electrodes, membrane-electrode assemblies and electrode assemblies of the present disclosure.

### FIELD

The present invention generally relates to porous electrodes, membrane-electrode assemblies and electrode assemblies useful in the fabrication of electrochemical cells and batteries. The disclosure further provides methods of making the porous electrodes.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one embodiment, the present disclosure provides a membrane-electrode assembly for a liquid flow battery comprising:
an ion exchange membrane having a first surface and an opposed second surface; and
a first porous electrode, having a first major surface and a second major surface, comprising:
   non-electrically conductive, polymer particulate fibers in the form of a first porous substrate, wherein the first porous substrate is at least one of a woven or nonwoven paper, felt, mat and cloth; and
   electrically conductive carbon particulate embedded in the pores of the first porous substrate and adhered directly to the surface of the non-electrically conductive, polymer particulate fibers of the first porous substrate; and

wherein the first major surface of the first porous electrode is proximate to or in contact with the first surface of the ion exchange membrane.

In another embodiment, the membrane-electrode assembly may further include a second porous electrode, having a first major surface and a second major surface, comprising:

non-electrically conductive polymer particulate fibers in the form of a second porous substrate, wherein the second porous substrate is at least one of a woven or nonwoven paper, felt, mat and cloth; and

electrically conductive carbon particulate embedded in the pores of the second porous substrate and adhered directly to the surface of the non-electrically conductive, polymer particulate fibers of the second porous substrate; and wherein the first major surface of the second porous electrode is proximate to or in contact with the second surface of the ion exchange membrane.

In another embodiment, the present disclosure provides an electrode assembly for a liquid flow battery comprising:
a first porous electrode, having a first major surface and a second major surface, comprising:
   non-electrically conductive polymer particulate fibers in the form of a first porous substrate, wherein the first porous substrate is at least one of a woven or nonwoven paper, felt, mat and cloth; and
   electrically conductive carbon particulate embedded in the pores of the first porous substrate and adhered directly to the surface of the non-electrically conductive, polymer particulate fibers of the first porous substrate; and
a first microporous protection layer having a first surface and an opposed second surface; and

wherein the first major surface of the first porous electrode is proximate the first major surface of the first microporous protection layer, and wherein the first microporous protection layer comprises a polymer resin and an electrically conductive carbon particulate and, optionally, a non-electrically conductive particulate.

In another embodiment, the present disclosure provides a porous electrode for a liquid flow battery, having a first major surface and a second major surface, comprising:
non-electrically conductive, polymer particulate fibers in the form of a first porous substrate, wherein the first porous substrate is at least one of a woven or nonwoven paper, felt, mat and cloth;
and electrically conductive carbon particulate embedded in the pores of the first porous substrate and adhered directly to the surface of the non-electrically conductive, polymer particulate fibers of the first porous substrate; and

wherein the porous electrode has an electrical resistivity of less than about 100000 μOhm·m.

In yet another embodiment, the present disclosure provide a porous electrode for a liquid flow battery, having a first major surface and a second major surface, comprising:
non-electrically conductive, polymer particulate fibers in the form of a first porous substrate, wherein the first porous substrate is at least one of a woven or nonwoven paper, felt, mat and cloth;
and electrically conductive carbon particulate embedded in the pores of the first porous substrate and adhered directly to the surface of the non-electrically conductive, polymer particulate fibers of the first porous substrate; and

wherein the porous electrode has a thickness between from about 10 microns to about 1000 microns.

In another embodiment, the present disclosure provides an electrochemical cell for a liquid flow battery comprising a membrane-electrode assembly according to any one of the membrane-electrode assembly embodiments disclosed herein.

In another embodiment, the present disclosure provides an electrochemical cell for a liquid flow battery comprising at least one electrode assembly according to any one of the electrode assembly embodiments disclosed herein.

In another embodiment, the present disclosure provides a liquid flow battery comprising at least one membrane-electrode assembly according to any one of the membrane-electrode assembly embodiments disclosed herein.

In another embodiment, the present disclosure provides liquid flow battery comprising at least one electrode assembly according to any one of the electrode assembly embodiments disclosed herein.

In another embodiment, the present disclosure provides an electrochemical cell for a liquid flow battery comprising at least one porous electrode according to anyone of the porous electrode embodiments disclosed herein.

In another embodiment, the present disclosure provides a liquid flow battery comprising at least one porous electrode according to anyone of the porous electrode embodiments disclosed herein.

In the porous electrodes, membrane-electrode assemblies and electrode assemblies of the present disclosure, and electrochemical cells for a liquid flow battery and liquid flow batteries therefrom, the porous substrate, which includes non-electrically conductive, polymer particulate fibers, may act as an inexpensive scaffolding that supports the electrically conductive particulate adhered directly to its surface. This construction enables large amounts of the active surface of the electrically conductive particulate to be available for oxidation-reduction reactions while maintaining at least a desired amount of porosity of the porous substrate, both features being required in, for example, liquid flow battery electrode applications. Unlike other approaches where the electrically conductive particulate may be mixed with a polymer binder resin, coating the majority of the electrically conductive particulate surfaces with the binder resin, and then bonded via curing/drying of the binder resin to a porous substrate, the electrodes of the present disclosure and corresponding membrane-electrode assemblies and electrode assemblies fabricated therefrom may be free of a binder resin that coats the majority of the surface of the electrically conductive particulates. Thus, the porous electrodes of the present disclosure may have improved electrical and/or electrochemical performance, as the majority of the surface of the electrically conductive particulate is available for oxidation-reduction reactions and the porosity of the porous electrode enables chemical reactants, e.g. anolyte and catholyte, to have access to these surfaces.

In the embodiments of the present disclosure, the electrode may be in the form of a sheet.

### BRIEF DESCRIPTION OF THE DRAWINGS

FIG. 1A shows a schematic plan view of an exemplary electrode according to one exemplary embodiment of the present disclosure.

FIG. 1B shows a schematic plan view of region 40′ of the exemplary electrode of FIG. 1A.

FIG. 2A is a schematic cross-sectional side view of an exemplary membrane-electrode assembly according to one exemplary embodiment of the present disclosure.

FIG. 2B shows a schematic cross-sectional side view of an exemplary membrane-electrode assembly according to one exemplary embodiment of the present disclosure.

FIG. 2C is a schematic cross-sectional side view of an exemplary membrane-electrode assembly according to one exemplary embodiment of the present disclosure.

FIG. 2D is a schematic cross-sectional side view of an exemplary membrane-electrode assembly according to one exemplary embodiment of the present disclosure.

FIG. 3 is a schematic cross-sectional side view of an exemplary electrode assembly according to one exemplary embodiment of the present disclosure.

FIG. 4 is a schematic cross-sectional side view of an exemplary electrochemical cell according to one exemplary embodiment of the present disclosure.

FIG. 5 is a schematic cross-sectional side view of an exemplary electrochemical cell stack according to one exemplary embodiment of the present disclosure.

FIG. 6 is a schematic view of an exemplary single cell liquid flow battery according to one exemplary embodiment of the present disclosure.

FIG. 7 is an image of the one of the graphite plates, having four, serpentine flow channels used in the Electrical Resistivity Test Method of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure, if a surface of a first substrate is in “contact” with the surface of a second substrate, at least a portion of the two surfaces are in physical contact, i.e. there is no intervening substrate(s) disposed between the two substrates.

Throughout this disclosure, if a layer or a surface of a layer is “adjacent” to a second layer or a surface of a second layer, the two nearest surfaces of the two layers are considered to be facing one another. They may be in contact with one another or they may not be in contact with one another, an intervening third layer(s) or substrate(s) being disposed between them.

Throughout this disclosure, if a surface of a first substrate is “proximate” to a surface of a second substrate, the two surface are considered to be facing one another and to be in close proximity to one another, i.e. to be within less than 500 microns, less than 250 microns, less than 100 microns or even in contact with one another. However, there may be one or more intervening substrates disposed between the first two substrate surfaces.

### DETAILED DESCRIPTION

A single electrochemical cell, which may be used in the fabrication of a liquid flow battery (e.g. a redox flow battery), generally, include two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The anode and/or cathode and membrane of the cell or battery will be referred to herein as a membrane-electrode assembly (MEA). In a redox flow battery containing a single electrochemical cell, for example, the cell would also include two current collectors, one adjacent to and in contact with the exterior surface of the anode flow plate, e.g. a monopolar or bipolar plate, and one adjacent to and in contact with the exterior surface of the cathode flow plate, e.g. a monopolar or bipolar plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolylte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size, power density (current density multiplied by the voltage) and number of electrode-membrane assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the membrane. Thus, the material making up the ion permeable membrane may be an expensive specialty polymer.

As hundreds of MEAs may be required per cell stack and battery, the electrodes (anode and cathode) and/or ion permeable membrane may be a significant cost factor with respect to the overall cost of the MEA and the overall cost of a cell and battery. Thus, there is a need for new electrodes that can reduce the cost of the MEAs and the overall cost of a cell and/or battery.

Additionally, as it is desirable to minimize the cost of the MEAs, another approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff fibers, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved electrodes useful in membrane-electrode assemblies that can prevent this localized shorting while maintaining the required electrolyte transport through the electrode without inhibiting the required oxidation/reduction reaction of the electrochemical cells and batteries fabricated therefrom.

The present disclosure provides porous electrodes having a new design that includes at least one polymer and at least one conductive carbon particulate. The addition of polymer may reduce the cost of the porous electrode compared to the cost of traditional carbon fiber based electrodes, e.g. carbon papers. The electrodes of the present disclosure, may also reduce the localized shorting that has been found to be an issue when the membrane thickness is reduced and may allow for even thinner membranes to be used, further facilitating cost reduction of the MEAs and corresponding cells and batteries made therefrom. The porous electrodes of the present disclosure are useful in the fabrication of membrane-electrode assemblies, electrode assemblies, liquid flow, e.g. redox flow, electrochemical cells and batteries. Liquid flow electrochemical cells and batteries may include cells and batteries having a single half-cell being a liquid flow type or both half-cells being a liquid flow type. The electrode may be a component of a membrane-electrode assembly or a component of an electrode assembly and the assemblies may also be useful in the fabrication of liquid flow, e.g. redox flow, electrochemical cells and batteries. An electrode assembly includes a porous electrode and at least one microporous protection layer. The membrane-electrode assemblies of the present disclosure may also include at least one microporous protection layer. A microporous protection layer is a substrate disposed between the membrane and electrode, which reduces the shorting of a cell which may be caused by fibers of the electrode penetrating through the membrane.

The present disclosure also includes liquid flow electrochemical cells and batteries, membrane-electrode assemblies and/or electrode assemblies that include at least one porous electrode of the present disclosure. The present disclosure further provides methods of fabricating the porous electrodes, membrane-electrode assemblies and electrode assemblies useful in the fabrication of liquid flow electrochemical cells and batteries.

The present disclosure provides a porous electrode for a liquid flow battery comprising polymer, e.g. polymer particulate, and electrically conductive carbon particulate. In one embodiment, the present disclosure provides a porous electrode, having a first major surface and a second major surface, including polymer particulate, wherein the polymer particulate is non-electrically conductive, polymer particulate fibers in the form of a first porous substrate, wherein the first porous substrate is at least one of a woven or nonwoven substrate; and electrically conductive carbon particulate embedded in, i.e. contained in, the pores of the first porous substrate and adhered directly to the surface of the non-electrically conductive, polymer particulate fibers of the first porous substrate. In some embodiments, the at least one of a woven or nonwoven substrate may be at least one of a woven or nonwoven paper, felt, mat and cloth. In some embodiments, the first porous substrate consists essentially of a woven substrate, e.g. consist essentially of at least one of a woven paper, felt, mat and cloth. In some embodiments, the first porous substrate consists essentially of a nonwoven substrate, e.g. consist essentially of at least one of a nonwoven paper, felt, mat and cloth. The electrically conductive carbon particulate of the porous electrode may be at least one of carbon particles, carbon flakes, carbon fibers, carbon dendrites, carbon nanotubes and branched carbon nanotubes. The electrically conductive carbon particulate of the porous electrode may be least one of or consist essentially of at least one of carbon nanotubes and branched carbon nanotubes. The electrically conductive carbon particulate of the porous electrode may be least one of or consist essentially of at least one of carbon particles, carbon flakes and carbon dendrites. The electrically conductive carbon particulate of the porous electrode may be at least one of or consist essentially of at least one of graphite particles, graphite flakes, graphite fibers and graphite dendrites. In some embodiments, at least a portion of the non-electrically conductive polymer particulate fibers of the first porous substrate has a core-shell structure, wherein the core-shell structure includes an inner core comprising a first polymer and an outer shell comprising a second polymer and, optionally, the second polymer has a softening temperature that is lower than softening temperature of the first polymer. In some embodiments, the porous electrode has an electrical resistivity of less than about 100000 μOhm·m (microOhm meter). In some embodiments, the porous electrode has a thickness from about 10 microns to about 1000 microns. In some embodiments, the porous electrode has a density from about 0.1 g/cm³ to about 1 g/cm³. In some embodiments, the amount of electrically conductive carbon particulate contained in the porous electrode is from about 5 to about 99 percent by weight.

An electrode is considered “porous” if it allows a liquid to flow from one exterior surface of a 3-dimensional porous electrode structure containing the porous electrode material to the exterior of an opposing surface of the 3-dimensional structure.

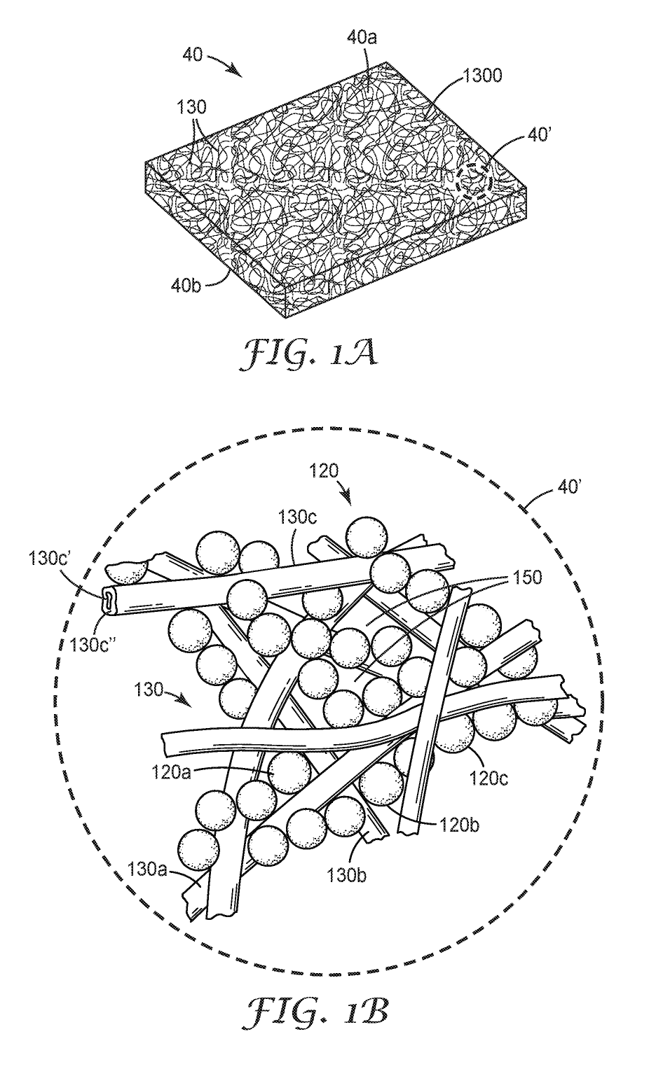

FIG. 1A, a schematic plan view of an exemplary electrode according to one exemplary embodiment of the present disclosure, shows porous electrode 40, having first major surface 40a and second major surface 40b. Porous electrode 40 includes porous substrate 1300. Porous substrate 1300 is formed from non-electrically conductive, polymer particulate fibers 130. Porous electrode 40 also includes electrically conductive carbon particulate embedded in, i.e. contained in, the pores of the first porous substrate (not shown). FIG. 1B, a schematic plan view of region 40′ of the exemplary electrode of FIG. 1A, shows non-electrically conductive, polymer particulate fibers 130, which include non-electrically conductive, polymer particulate fibers 130a, 130b and 130c and electrically conductive carbon particulate 120, which includes electrically conductive carbon particles 120a, 120b and 120c. Electrically conductive carbon particulate 120 is embedded in, i.e. contained in, the pores 150 of the first porous substrate 1300 and adhered directly to the surface of non-electrically conductive, polymer particulate fibers 130 of first porous substrate 1300, e.g. electrically conductive carbon particles 120a, 120b and 120c are adhered directly to the surface of non-electrically conductive, polymer particulate fibers 130.

As only a small fraction of the surface area of each individual electrically conductive carbon particulate is required for adhering the electrically conductive carbon particulate to the non-electrically conductive, polymer particulate fibers, adhering the electrically conductive carbon particulate directly to the surface of non-electrically conductive, polymer particulate fibers enables the majority of the surface area of the electrically conductive carbon particulate to be available for electrochemical reactions, required for use in, for example, liquid flow batteries. This is in contrast to prior art approaches that use a binder resin, typically mixing electrically conductive particulate with a binder resin and then using the binder resin to adhere/bond the electrically conductive particulate to a porous substrate. In this prior approach, which does not adhere the electrically conductive particulate directly to the surface of the porous substrate, e.g. directly to the surface of fibers that form the porous substrate, use of a binder resin coats a significant portion, typically at least 40%, at least 50%, at least 60%, at least 70%, at least 80%, at least 90% or even 100% of the surface, i.e. surface area, of the electrically conductive particulate, with the binder resin and significantly lowers the amount of surface area of the electrically conductive particulate available for electrochemical reactions.

In some embodiments, at least from about 40% to about 85%, from about 40% to about 90% from about 40% to about 95%, from about 40% to about 98%, from about 50% to about 85%, from about 50% to about 90% from about 50% to about 95%, from about 50% to about 98%, from about 60% to about 85%, from about 60% to about 90% from about 60% to about 95%, from about 60% to about 98%, from about 70% to about 85%, from about 70% to about 90% from about 70% to about 95%, or even from about 70% to about 98%, of the surface, i.e. surface area, of the electrically conductive carbon particulates; adhered directly to the surface of non-electrically conductive, polymer particulate fibers; is free of a resin, e.g. a polymer resin and a polymer binder resin. Having a large amount of surface area of the electrically conductive carbon particulates available for electrochemical reactions improves the electrochemical performance of the porous electrodes of the present disclosure.

With respect to non-electrically conductive, polymer particulate fibers 130 of FIG. 1B, fiber 130c is shown to have a core-shell structure having an inner core 130c′ and an outer shell 130c″. The inner core may include a first polymer and the outer shell may include a second polymer. The composition of the first polymer may be different from the composition of the second polymer.

The term “particulate”, with respect to both an electrically conductive carbon particulate and a polymer particulate is meant to include particles, flakes, fibers, dendrites and the like. Particulate particles generally include particulates that have aspect ratios of length to width and length to thickness both of which are between about 1 and about 5. Particle size may be from between about 0.001 microns to about 100 microns, from between about 0.001 microns to about 50 microns, from between about 0.001 to about 25 microns, from between about 0.001 microns to about 10 microns, from about 0.001 microns to about 1 microns, from between about 0.01 microns and about 100 microns, from between about 0.01 microns to about 50 microns, from between about 0.01 to about 25 microns, from between about 0.01 microns to about 10 microns, from about 0.01 microns to about 1 microns, from between about 0.05 microns to about 100 microns, from between about 0.05 microns to about 50 microns, from between about 0.05 to about 25 microns, from between about 0.05 microns to about 10 microns, from about 0.05 microns to about 1 microns, from between about 0.1 microns and about 100 microns, from between about 0.1 microns to about 50 microns, from between about 0.1 to about 25 microns, from between about 0.1 microns to about 10 microns, or even from between about 0.1 microns to about 1 microns. Particles may be spheroidal in shape. Particulate flakes generally include particulates that have a length and a width each of which is significantly greater than the thickness of the flake. A flake includes particulates that have aspect ratios of length to thickness and width to thickness each of which is greater than about 5. There is no particular upper limit on the length to thickness and width to thickness aspect ratios of a flake. Both the length to thickness and width to thickness aspect ratios of the flake may be between about 6 and about 1000, between about 6 and about 500, between about 6 and about 100, between about 6 and about 50, between about 6 and about 25, between about 10 and about 500, between 10 and about 150, between 10 and about 100, or even between about 10 and about 50. The length and width of the flake may each be from between about 0.001 microns to about 50 microns, from between about 0.001 to about 25 microns, from between about 0.001 microns to about 10 microns, from about 0.001 microns to about 1 microns, from between about 0.01 microns to about 50 microns, from between about 0.01 to about 25 microns, from between about 0.01 microns to about 10 microns, from about 0.01 microns to about 1 microns, from between about 0.05 microns to about 50 microns, from between about 0.05 to about 25 microns, from between about 0.05 microns to about 10 microns, from about 0.05 microns to about 1 microns, from between about 0.1 microns to about 50 microns, from between about 0.1 to about 25 microns, from between about 0.1 microns to about 10 microns, or even from between about 0.1 microns to about 1 microns. Flakes may be platelet in shape.

Particulate dendrites include particulates having a branched structure. The particle size of the dendrites may be the same as those disclosed for the particulate particles, discussed above.

Particulate fibers generally include particulates that have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 100 microns, from between about 0.001 microns to about 50 microns, from between about 0.001 to about 25 microns, from between about 0.001 microns to about 10 microns, from about 0.001 microns to about 1 microns, from between about 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same.

The particulate fibers of the present disclosure may be fabricated into at least one of a woven or nonwoven paper, felt, mat and/or cloth. A nonwoven, e.g. a nonwoven mat, may be fabricated by a melt blown fiber process, spunbond process, a carding process and the like. In some embodiments, the aspect ratio of both the length to thickness and length to width aspect ratios of the particulate fiber may be greater than 1000000, greater than about 10000000 greater than about 100000000 or even greater than about 1000000000. In some embodiments, the aspect ratio of both the length to thickness and length to width aspect ratios of the particulate fiber may be between about 10 to about 1000000000; between about 10 and about 100000000 between about 10 and about 10000000, between about 20 to about 1000000000; between about 20 and about 100000000 between about 20 and about 10000000, between about 50 to about 1000000000; between about 50 and about 100000000 or even between about 50 and about 10000000.

The electrically conductive carbon particulate, includes but is not limited to, glass like carbon, amorphous carbon, graphene, graphite, e.g. graphitized carbon, carbon dendrites, carbon nanotubes, branched carbon nanotubes, e.g. carbon nanotrees. In some embodiments, the electrically conductive carbon particulate is at least one of carbon particles, carbon flakes, carbon fibers, carbon dendrites, carbon nanotubes and branched carbon nanotubes, e.g. carbon nanotrees. Combinations of electrically conductive carbon particulate types may be used. The electrically conductive carbon particulate of the porous electrode may include or may consist essentially of at least one of carbon particles, carbon flakes and carbon dendrites. In some embodiments, the electrically conductive carbon particulate may include or may consist essentially of at least one of graphite particles, graphite flakes, graphite fibers and graphite dendrites. In some embodiments, the graphite may include or may consist essentially of at least one of graphite particles, graphite flakes, and graphite dendrites. In some embodiments, the electrically conductive carbon particulate does not include carbon fibers, e.g. graphite fibers.

In some embodiments, the electrically conductive particulate is at least one of carbon nanotubes and branched carbon nanotubes. Carbon nanotubes are allotropes of carbon with a cylindrical nanostructure. Carbon nanotubes may be produced with length-to-diameter ratio of up to 132,000,000:1, significantly larger than for any other material, including carbon fiber. Carbon nanotubes may have diameters of from about 1 to 5 nanometers, orders of magnitude smaller than carbon and/or graphite fibers, which may have diameters from 5 to about 10 microns. Carbon nanotubes may have a diameter from about 0.3 nanometers to about 100 nanometers, from about 0.3 nanometers to about 50 nanometers, from about 0.3 nanometers to about 20 nanometers, from about 0.3 nanometers to about 10 nanometers, from about 1 nanometer to about 50 nanometers, from about 1 nanometer to about 20 nanometers, or even from about 1 nanometers to about 10 nanometers. Carbon nanotubes may have a length between about 0.25 microns and about 1000 microns, between about 0.5 microns and about 500 microns, or even between about 1 micron and about 100 microns. Branched carbon nanotubes, e.g. nanotrees may have a diameter from about 0.3 nanometers to about 100 nanometers. Branched carbon nanotubes include multiple, carbon nanotube side branches that are covalently bonded with the main carbon nanotube, i.e. the carbon nanotube stem. Branched carbon nanotubes, with their tree-like, dendritic geometry, may have extensively high surface area. Various synthesis methods have been developed to fabricate such complex structured carbon nanotubes with multiple terminals, including but not limited to the template method, carbon nanotube welding method, solid fiber carbonization, as well as the direct current plasma enhanced chemical vapor deposition (CVD) and several other additive-, catalyst-, or flow fluctuation-based CVD methods. In some embodiments, the diameter of the main carbon nanotube and the diameter of the carbon nanotube side branches of branched carbon nanotubes may be from about 0.3 nanometers to about 100 nanometers, from about 0.3 nanometers to about 50 nanometers, from about 0.3 nanometers to about 20 nanometers, from about 0.3 nanometers.

In some embodiments, the electrically conductive particulate may include or consist essentially of at least one of carbon nanotubes and branched carbon nanotubes. In some embodiments, the electrically conductive carbon particulate includes or consists essentially of carbon nanotubes and branched carbon nanotubes and the weight fraction of branched carbon nanotubes, relative to the total weight of carbon nanotubes and branched carbon nanotubes, may be from about 0.1 to about 1, from about 0.1 to about 0.9, from about 0.1 from 0.8, from about 0.2 to about 1, from about 0.2 to about 0.9, from about 0.2 from 0.8, from about 0.3 to about 1, from about 0.3 to about 0.9, from about 0.3 from 0.8, from about 0.4 to about 1, from about 0.4 to about 0.9, from about 0.4 from 0.8, from about 0.5 to about 1, from about 0.5 to about 0.9, or even from about 0.5 from 0.8. The electrically conductive particulate which includes at least one of carbon nanotubes and branched carbon nanotubes and/or which includes carbon nanotubes and branched carbon nanotubes may further comprise graphite particulate. In these embodiments, the weight fraction of graphite particulate to the total weight of electrically conductive carbon particulate may be from about 0.05 to about 1, from about 0.05 to about 0.8, from about 0.05 to about 0.6, from about 0.05 to about 0.5, from about 0.05 to about 0.4, from about 0.1 to about 1, from about 0.1 to about 0.8, from about 0.1 to about 0.6, from about 0.1 to about 0.5, from about 0.1 to about 0.4, from about 0.2 to about 1, from about 0.2 to about 0.8, from about 0.2 to about 0.6, from about 0.2 to about 0.5, or even from about 0.2 to about 0.4.

In some embodiments, the electrically conductive carbon particulate may be surface treated. Surface treatment may enhance the wettability of the porous electrode to a given anolyte or catholyte or to provide or enhance the electrochemical activity of the electrode relative to the oxidation-reduction reactions associated with the chemical composition of a given anolyte or catholyte. Surface treatments include, but are not limited to, at least one of chemical treatments, thermal treatments and plasma treatments. In some embodiments, the electrically conductive carbon particulate has enhanced electrochemical activity, produced by at least one of chemical treatment, thermal treatment and plasma treatment. The term “enhanced” means that the electrochemical activity of the electrically conductive carbon particulate is selectively increased after treatment relative to the electrochemical activity of the electrically conductive carbon particulate prior to treatment. Enhanced electrochemical activity may include at least one of increased current density, reduced oxygen evolution and reduced hydrogen evolution at a defined potential. One method of measuring enhanced electrochemical activity is through the construction of an electrochemical cell containing the electrically conductive carbon particulate (prior to and after treatment). Differentiation between samples is made by monitoring the current generated at a defined applied voltage. Enhancement in oxygen and hydrogen evolution can be monitored through the use of electrochemical techniques such as cyclic voltammetry in a half-cell arrangement. In this test, enhanced performance results in smaller redox peak separation and higher voltages required before electrolyte breakdown is observed. In some embodiments, the electrically conductive particulate is hydrophilic.

In some embodiments, the amount of electrically conductive carbon particulate contained in the porous electrode, on a weight basis, may be from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, 25 to about 95 percent, from about 25 to about 90 percent, from about 25 to about 80 percent, from about 25 to about 70 percent, from about 30 to about 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to about 99 percent, 50 to about 95 percent, from about 50 to about 90 percent, from about 50 to about 80 percent, from about 50 to about 70 percent, from about 60 to about 99 percent, 60 to about 95 percent, from about 60 to about 90 percent, from about 60 to about 80 percent, or even from about 60 to about 70 percent.

The polymer of the porous electrode may be a polymer particulate, e.g. a non-electrically conductive, polymer particulate. In some embodiments, the polymer particulate is non-electrically conductive, polymer particulate fibers. In some embodiments, the polymer particulate is fused polymer particulate. Fused polymer particulate may be formed from polymer particulates that are brought to a temperature to allow the contact surfaces of adjacent polymer particulates to fuse together. After fusing the individual particulates that formed the fused polymer particulate can still be identified. A fused polymer particulate is porous. Fused polymer particulate is not particulate that has been completely melted to form a solid substrate, i.e. a non-porous substrate. In some embodiments, the polymer particulate may be fused at a temperature that is not less than about 60 degrees centigrade, not less than about 50 degrees centigrade, not less than about 40 degrees centigrade, not less than about 30 degrees centigrade, not less than about 20 degrees centigrade or even not less than about 10 degrees centigrade lower than the lowest glass transition temperature of the polymer particulate. The polymer particulate may have more than one glass transition temperatures, if, for example, the polymer particulate is a block copolymer, polymer blend or a core-shell polymer. For a polymer particulate fiber the term “core-sheath” may be used to describe a fiber having an inner core containing a first polymer and an outer shell or sheath containing a second polymer. However, throughout this disclosure the term core-shell is meant to encompass all polymer particulate types; polymer particulate particles, polymer particulate flakes, polymer particulate fibers and polymer particulate dendrites; that include a first polymer type which acts as a core and a second polymer type that acts as a shell or sheath. In some embodiments, the polymer particulate may be fused at a temperature that is below the highest melting temperature of the polymer particulate or, when the polymer particulate is an amorphous polymer, no greater than 50 degrees centigrade, no greater than 30 degrees centigrade or even no greater than 10 degrees centigrade above the highest glass transition temperature of the polymer particulate.

In some embodiments, the polymer particulate is non-electrically conductive, polymer particulate fibers in the form of a first porous substrate, the first porous substrate may be in the form of at least one of a woven or nonwoven paper, felt, mat and cloth (i.e. fabric). Conventional woven and nonwoven paper, felt, mats and cloth known in the art may be used in the porous electrodes and membrane-electrode assemblies, electrode assemblies, electrochemical cells and batteries containing said porous electrodes. The number of types, i.e. polymer types, of non-electrically conductive polymer particulate fiber used to form the first porous substrate is not particularly limited. The non-electrically conductive polymer particulate fibers include at least one polymer, e.g. one polymer composition or polymer type. The non-electrically conductive polymer particulate fibers may include at least two polymers, i.e. two polymer compositions or two polymer types. For example, the non-electrically conductive polymer particulate fiber used to form the first porous substrate may include one set of fibers composed of polyethylene and another set of fibers composed of polypropylene. If at least two polymers are used, the first polymer may have a lower glass transition temperature than the second polymer. The first polymer may be used for fusing the non-electrically conductive, polymer particulate fibers of the first porous substrate together to improve the mechanical properties of the porous substrate or to facilitate adherence, e.g. bonding, of the electrically conductive carbon particulate to the surface of the non-electrically conductive, polymer particulate fibers of the first porous substrate.

The polymer, e.g. non-electrically conductive polymer particulate fiber, of the porous electrode may be selected to facilitate the transfer of select ion(s) of the electrolytes through the electrode. This may be achieved by allowing the electrolyte to easily wet a given polymer. The material properties, particularly the surface wetting characteristics of the polymer may be selected based on the type of anolyte and catholyte solution, i.e. whether they are aqueous based or non-aqueous based. As disclosed herein, an aqueous based solution is defined as a solution wherein the solvent includes at least 50% water by weight. A non-aqueous base solution is defined as a solution wherein the solvent contains less than 50% water by weight. In some embodiments, the polymer of the porous electrode may be hydrophilic. This may be particularly beneficial when the electrode is to be used in conjunction with aqueous anolyte and/or catholyte solutions. In some embodiments, the polymer may have a surface contact angle with water, catholyte and/or anolyte of less than 90 degrees. In some embodiments, the polymer may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

Polymer of the porous electrode, e.g. non-electrically conductive polymer particulate fiber, may include thermoplastic resins (including thermoplastic elastomer), thermoset resins (including glassy and rubbery materials) and combinations thereof. Useful thermoplastic resins include, but are not limited to, homopolymers, copolymers and blends of at least one of polyalkylenes, e.g. polyethylene, high molecular weight polyethylene, high density polyethylene, ultra-high molecular weight polyethylene, polypropylene, high molecular weight polypropylene; polyacrylates; polymethacrylates, styrene and styrene based random and block copolymers, e.g. styrene-butadiene-styrene; polyesters, e.g. polyethylene terephtahalate; polycarbonates, polyamides, polyamide-amines; polyalkylene glycols, e.g. polyethylene glycol and polypropylene glycol; polyurethanes; polyethers; chlorinated polyvinyl chloride; fluoropolymers including perfluorinated fluoropolymers, e.g. polytetrafluoroethylene (PTFE) and partially fluorinated fluoropolymer, e.g. polyvinylidene fluoride, each of which may be semi-crystalline and/or amorphous; polyimides, polyetherimides, polysulphones; polyphenylene oxides; and polyketones. Useful thermoset resins include, but are not limited to, homopolymer, copolymers and/or blends of at least one of epoxy resin, phenolic resin, polyurethanes, urea-formadehyde resin and melamine resin. Polymer of the porous electrode, e.g. polymer particulate fiber, may be a B-stage polymer, e.g. a polymer capable of forming a network structure via a two-step curing process that may include on or more curing mechanism, e.g. thermal curing and/or actinic radiation curing.

In some embodiments, the polymer of the porous electrode, e.g. non-electrically conductive polymer particulate fiber, has a softening temperature, e.g. the glass transition temperature and/or the melting temperature of between about 20 degrees centigrade and about 400 degrees centigrade, between about 20 degrees centigrade and about 350 degrees centigrade, between about 20 degrees centigrade and about 300 degrees centigrade, between about 20 degrees centigrade and about 250 degrees centigrade, between about 20 degrees centigrade and about 200 degrees centigrade, between about 20 degrees centigrade and about 150 degrees centigrade, between about 35 degrees centigrade and about 400 degrees centigrade, between about 35 degrees centigrade and about 350 degrees centigrade, between about 35 degrees centigrade and about 300 degrees centigrade, between about 35 degrees centigrade and about 250 degrees centigrade, between about 35 degrees centigrade and about 200 degrees centigrade, between about 35 degrees centigrade and about 150 degrees centigrade, between about 50 degrees centigrade and about 400 degrees centigrade, between about 50 degrees centigrade and about 350 degrees centigrade, between about 50 degrees centigrade and about 300 degrees centigrade, between about 50 degrees centigrade and about 250 degrees centigrade, between about 50 degrees centigrade and about 200 degrees centigrade, between about 50 degrees centigrade and about 150 degrees centigrade, between about 75 degrees centigrade and about 400 degrees centigrade, between about 75 degrees centigrade and about 350 degrees centigrade, between about 75 degrees centigrade and about 300 degrees centigrade, between about 75 degrees centigrade and about 250 degrees centigrade, between about 75 degrees centigrade and about 200 degrees centigrade, or even between about 75 degrees centigrade and about 150 degrees centigrade.

In some embodiments, the polymer particulate, e.g. non-electrically conductive polymer particulate fiber, is composed of two or more polymers and has a core-shell structure, i.e. an inner core comprising a first polymer and an outer shell comprising a second polymer. In another embodiment, non-electrically conductive, polymer particulate fibers of at least one fiber type, composed of at least one first polymer (which may include a homopolymer, copolymer or polymer blend) may be used to form a first porous core substrate and a coating composition, including at least one of a polymer solution and a reactive polymer precursor solution, may be disposed on the first porous core substrate. The coating composition may be at least one of dried and cured to form a first porous substrate, wherein at least a portion of the fibers of the first porous substrate have a core-shell structure. The core being composed of the at least one first polymer and the shell being formed of a second polymer, i.e. the dried and/or cured polymer formed from the coating composition. The electrically conductive carbon particulate may then be adhered directly to the surface of the non-electrically conductive, polymer particulate fibers of the first porous substrate, having a core-shell structure, prior to, during and/or after drying and/or curing of the coating composition.

In some embodiments, the polymer of the outer shell, e.g. the second polymer, has a softening temperature, e.g. the glass transition temperature and/or the melting temperature, that is lower than the softening temperature of the first polymer. In some embodiments, the second polymer has a softening temperature, e.g. the glass transition temperature and/or the melting temperature, of between about 20 degrees centigrade and about 400 degrees centigrade, between about 20 degrees centigrade and about 350 degrees centigrade, between about 20 degrees centigrade and about 300 degrees centigrade, between about 20 degrees centigrade and about 250 degrees centigrade, between about 20 degrees centigrade and about 200 degrees centigrade, between about 20 degrees centigrade and about 150 degrees centigrade, between about 35 degrees centigrade and about 400 degrees centigrade, between about 35 degrees centigrade and about 350 degrees centigrade, between about 35 degrees centigrade and about 300 degrees centigrade, between about 35 degrees centigrade and about 250 degrees centigrade, between about 35 degrees centigrade and about 200 degrees centigrade, between about 35 degrees centigrade and about 150 degrees centigrade, between about 50 degrees centigrade and about 400 degrees centigrade, between about 50 degrees centigrade and about 350 degrees centigrade, between about 50 degrees centigrade and about 300 degrees centigrade, between about 50 degrees centigrade and about 250 degrees centigrade, between about 50 degrees centigrade and about 200 degrees centigrade, between about 50 degrees centigrade and about 150 degrees centigrade, between about 75 degrees centigrade and about 400 degrees centigrade, between about 75 degrees centigrade and about 350 degrees centigrade, between about 75 degrees centigrade and about 300 degrees centigrade, between about 75 degrees centigrade and about 250 degrees centigrade, between about 75 degrees centigrade and about 200 degrees centigrade, or even between about 75 degrees centigrade and about 150 degrees centigrade.

The polymer of the porous electrode, e.g. non-electrically conductive polymer particulate, may be an ionic polymer or non-ionic polymer. Ionic polymer include polymer wherein a fraction of the repeat units are electrically neutral and a fraction of the repeat units have an ionic functional group, i.e. an ionic repeat unit. In some embodiments, the polymer is an ionic polymer, wherein the ionic polymer has a mole fraction of repeat units having an ionic functional group of between about 0.005 and about 1. In some embodiments, the polymer is a non-ionic polymer, wherein the non-ionic polymer has a mole fraction of repeat units having an ionic functional group of from less than about 0.005 to about 0. In some embodiments, the polymer is a non-ionic polymer, wherein the non-ionic polymer has no repeat units having an ionic functional group. In some embodiments, the polymer consists essentially of an ionic polymer. In some embodiments, the polymer consists essentially of a non-ionic polymer. Ionic polymer includes, but is not limited to, ion exchange resins, ionomer resins and combinations thereof. Ion exchange resins may be particularly useful.

As broadly defined herein, ionic resin include resin wherein a fraction of the repeat units are electrically neutral and a fraction of the repeat units have an ionic functional group. In some embodiments, the ionic resin has a mole fraction of repeat units with ionic functional groups between about 0.005 and 1. In some embodiments, the ionic resin is a cationic resin, i.e. its ionic functional groups are negatively charged and facilitate the transfer of cations, e.g. protons, optionally, wherein the cationic resin is a proton cationic resin. In some embodiments, the ionic resin is an anionic exchange resin, i.e. its ionic functional groups are positively charged and facilitate the transfer of anions. The ionic functional group of the ionic resin may include, but is not limited to, carboxylate, sulphonate, sulfonamide, quaternary ammonium, thiuronium, guanidinium, imidazolium and pyridinium groups. Combinations of ionic functional groups may be used in an ionic resin.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.03 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolomer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The polymer may be a mixture of ionomer resin and ion exchange resin.

In some embodiments, the amount of polymer particulate, e.g. non-electrically conductive polymer particulate fiber, contained in the porous electrode, on a weight basis, may be from about 1 to about 95 percent, from about 5 to about 95 percent, from about 10 to about 95 percent, from about 20 to about 95 percent, from about 30 to about 95 percent, from about 1 to about 90 percent, from about 5 to about 90 percent, from about 10 to about 90 percent, from about 20 to about 90 percent, from about 30 to about 90 percent, from about 1 to about 75 percent, from about 5 to about 75 percent, from about 10 to about 75 percent, from about 20 to about 75 percent, from about 30 to about 75 percent, from about 1 to about 70 percent, from about 5 to about 70 percent, from about 10 to about 70 percent, from about 20 to about 70 percent, from about 30 to about 70 percent, from about 1 to about 60 percent, from about 5 to about 60, from about 10 to about 60 percent, from about 20 to about 60 percent, from about 30 to about 60 percent, from about 1 to about 50 percent, 5 to about 50 percent, from about 10 to about 50 percent, from about 20 to about 50 percent, from about 30 to about 50 percent, from about 1 to about 40 percent, 5 to about 40 percent, from about 10 to about 40 percent, from about 20 to about 40 percent, or even from about 30 to about 40 percent.

In some embodiments, the porous electrodes of the present disclosure may contain a non-electrically conductive, inorganic particulate. Non-electrically conductive, inorganic particulate include, but is not limited to, minerals and clays known in the art. In some embodiments the non-electrically conductive inorganic particulate may be a metal oxide. In some embodiments the non-electrically conductive, inorganic particulate include at least one of silica, alumina, titania, and zirconia.

As previously discussed, the polymer particulate may be in the form of fiber and the fiber may be in the form of at least one of a woven or non-woven paper, felt, mat and cloth. More than one type of fiber may be used to form the at least one of a woven or non-woven paper, felt, mat or cloth. In some embodiments, the electrically conductive particulate is embedded into the pores of the at least one of a woven or non-woven paper, felt, mat and cloth and may also be embedded into the surface of the fibers comprising the at least one of a woven or non-woven paper, felt, mat or cloth, via agitation, which may be combined with pressure, forming a porous electrode. The electrically conductive particulate may foliate, e.g. via shear, forming thin layers of electrically conductive carbon platelets, e.g. graphite platelets, on or embedded in the surface of the fibers, e.g. the non-electrically conductive, polymer particulate fibers. The porous electrode may then be heat treated at temperatures near, at or above the softening temperature of the polymer fiber(s), e.g. the glass transition temperature and/or the melting temperature of the polymer fibers. The thermal treatment may aid in adhering the electrically conductive carbon particulate to the surface of the polymer fibers of the at least one of a woven or non-woven paper, felt, mat or cloth. The thermal treatment may be conducted under pressure, e.g. in a heated press or between heated rolls. The press and or heated rolls may be set to provide a specific desired gap, which may facilitate obtaining a desired electrode thickness, as the polymer fibers may further fuse together during the thermal treatment. The porous electrode may be in the form of a sheet.

In one embodiment, the present disclosure provides a method of making a porous electrode including providing non-electrically conductive, polymer particulate fibers in the form of a first porous substrate to a container, wherein the first porous substrate is at least one of a woven or nonwoven paper, felt, mat and cloth; providing electrically conductive carbon particulate to the container; providing milling media to the container; agitating the container to urge the electrically conductive carbon particulate into the pores of the first porous substrate and to directly adhere at least a portion of electrically conductive carbon particulate to the surface of the non-electrically conductive, polymer particulate fibers of the first porous substrate to form a porous electrode. The method of making the porous electrode may include an optional step of heating to fuse at least a portion of the non-electrically conductive, polymer particulate fibers together. The method of making the porous electrode may include an optional step of heating to directly adhere at least a portion of electrically conductive carbon particulate to the surface of the non-electrically conductive, polymer particulate fibers of the first porous substrate. The method of making the porous electrode may include an optional step of providing pressure to the first porous substrate or first porous electrode. In some embodiments, the heating step to fuse at least a portion of the non-electrically conductive, polymer particulate fibers together and the heating step to directly adhere at least a portion of electrically conductive carbon particulate to the surface of the non-electrically conductive, polymer particulate fibers of the first porous substrate may be done sequentially or simultaneously. In some embodiments, the step of providing pressure to the first porous substrate or first porous electrode may be conducted sequentially or simultaneously with either one or both of the steps of heating to fuse at least a portion of the non-electrically conductive, polymer particulate fibers together and heating to directly adhere at least a portion of electrically conductive carbon particulate to the surface of the non-electrically conductive, polymer particulate fibers of the first porous substrate.

Milling media used in the fabrication of the porous electrodes of the present disclosure may be that known in the art, including but not limited to metal and ceramics shaped structures, Shapes may include beads, balls, cubes, bars, rectangular prisms and the like. Heating used in the fabrication of the porous electrodes of the present disclosure may include, but is not limited to conventional oven heating, e.g. air flow through oven; infrared (IR) heating; ultraviolet (UV) heating and microwave heating. The use of milling media along with agitation thereof may also provide sufficient mechanical energy to create frictional heating during the fabrication process, thereby eliminating the need for further heating steps.

In one embodiment, a piece of nonwoven mat composed of at least one core-shell type fiber is place in a container. Electrically conductive carbon particulate, e.g. graphite particles, may be spread over the top of the nonwoven mat. Milling media, e.g. ceramic beads and/or steel beads, may be placed over the electrically conductive carbon particulate. The container may be sealed and shaken for a period of from between about one-quarter hours to about forty-eight hours, forming a porous electrode. The electrode may be subjected to a thermal treatment, near, at or above the softening temperature of the second polymer, i.e. the shell of the core-shell polymer, for a time of between about one-quarter hour to about forty-eight hours. The thermal treatment may aid in adhering the electrically conductive carbon particulate to the surface of the polymer fibers. The electrode may be subjected to a second thermal treatment, at a similar temperature and a similar time, this one under pressure, to adjust the thickness of the electrode.

The porous electrodes of the present disclosure may be washed using conventional techniques to remove loose carbon particulate. The washing technique may include and appropriate solvent, e.g. water, and/or surfactant to aid in the removal of loose carbon particulate. The electrodes of the present disclosure may be made by a continuous roll to roll process, the electrode sheet being wound to form a roll good.

In some embodiments, the porous electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments the porous electrode may have a surface contact angle with water, catholyte and/or anolyte of less than 90 degrees. In some embodiments, the porous electrode may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

In some embodiments, the porous electrode may be surface treated to enhance the wettability of the porous electrode to a given anolyte or catholyte or to provide or enhance the electrochemical activity of the electrode relative to the oxidation-reduction reactions associated with the chemical composition of a given anolyte or catholyte. Surface treatments include, but are not limited to, at least one of chemical treatments, thermal treatments and plasma treatments.

The thickness of the porous electrode may be from about 10 microns to about 10000 microns, from about 10 microns to about 5000 microns, from about 10 microns to about 1000 microns, from about 10 microns to about 500 microns, from about 10 microns to about 250 microns, from about 10 microns to about 100 microns, from about 25 microns to about 10000 microns, from about 25 microns to about 5000 microns, from about 25 microns to about 1000 microns, from about 25 microns to about 500 microns, from about 25 microns to about 250 microns, from about 25 microns to about 100 microns, from about 40 microns to about 10000 microns, from about 40 microns to about 5000 microns, from about 40 microns to about 1000 microns, from about 40 microns to about 750 microns, from about 40 microns to about 500 microns, from about 40 microns to about 250 microns, or even from about 40 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent. The porosity of the porous electrode may be constant throughout the porous electrode or may, for example, have a gradient in a given direction, e.g. the porosity may vary through the thickness of the porous electrode. The density of the porous electrode may be from about from about 0.1 g/cm³ to about 1 g/cm³, from about 0.1 g/cm³ to about 0.9 g/cm³, from about 0.1 g/cm³ to about 0.8 g/cm³, from about 0.1 g/cm³ to about 0.7 g/cm³, from about 0.2 g/cm³ to about 1 g/cm³, from about 0.2 g/cm³ to about 0.9 g/cm³, from about 0.2 g/cm³ to about 0.8 g/cm³, from about 0.2 g/cm³ to about 0.7 g/cm³, from about from about 0.3 g/cm³ to about 1 g/cm³, from about 0.3 g/cm³ to about 0.9 g/cm³, from about 0.3 g/cm³ to about 0.8 g/cm³, or even from about 0.3 g/cm³ to about 0.7 g/cm³. A lower density may be desired for the porous electrode, as it indicates an efficient use of electrically conductive carbon particulate, lowering the cost and/or weight of the porous electrode.

The porous electrode may be a single layer or multiple layers. When the porous electrode includes multiple layers, there is no particular limit as to the number of layers that may be used. However, as there is a general desire to keep the thickness of electrode and membrane-electrode assembly as thin as possible, the electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5. In some embodiments, when the electrode includes multiple layers, the electrode material of each layer may be the same electrode material, i.e. the composition of the electrode material of each layer is the same. In some embodiments, when the electrode includes multiple layers, the electrode material of at least one, up to including all of the layers, may be different, i.e. the composition of the electrode material of at least one, up to and including all layers, differs from the composition of the electrode material of another layer.

The porous electrodes of the present disclosure may have an electrical resistivity of from about 0.1 μOhm·m to about 100000 μOhm·m, from about 1 μOhm·m to about 100000 μOhm·m, from 10 μOhm·m to about 100000 μOhm·m, from about 0.1 μOhm·m to about 50000 μOhm·m, from about 1 μOhm·m to about 50000 μOhm·m, from 10 μOhm·m to about 50000 μOhm·m, from about 0.1 μOhm·m to about 30000 μOhm·m, from about 1 μOhm·m to about 30000 μOhm·m, from 10 μOhm·m to about 30000 μOhm·m, from about 0.1 μOhm·m to about 20000 μOhm·m, from about 1 μOhm·m to about 20000 μOhm·m, from 10 μOhm·m to about 20000 μOhm·m, from about 0.1 μOhm·m to about 15000 μOhm·m, from about 1 μOhm·m to about 15000 μOhm·m, from 10 μOhm·m to about 15000 μOhm·m, from about 0.1 μOhm·m to about 10000 μOhm·m, from about 1 μOhm·m to about 10000 μOhm·m, from 10 μOhm·m to about 10000 μOhm·m, from about 0.1 μOhm·m to about 1000 μOhm·m, from about 1 μOhm·m to about 1000 μOhm·m, from 10 μOhm·m to about 1000 μOhm·m, from about 0.1 μOhm·m to about 100 μOhm·m, from about 1 μOhm·m to about 100 μOhm·m, or even from about 10 μOhm·m to about 100 μOhm·m. In some embodiments, porous electrodes of the present disclosure may have an electrical resistivity of less than about 100000 μOhm·m, 10000 μOhm·m, less than about 1000 μOhm·m, or even less than about 100 μOhm·m.

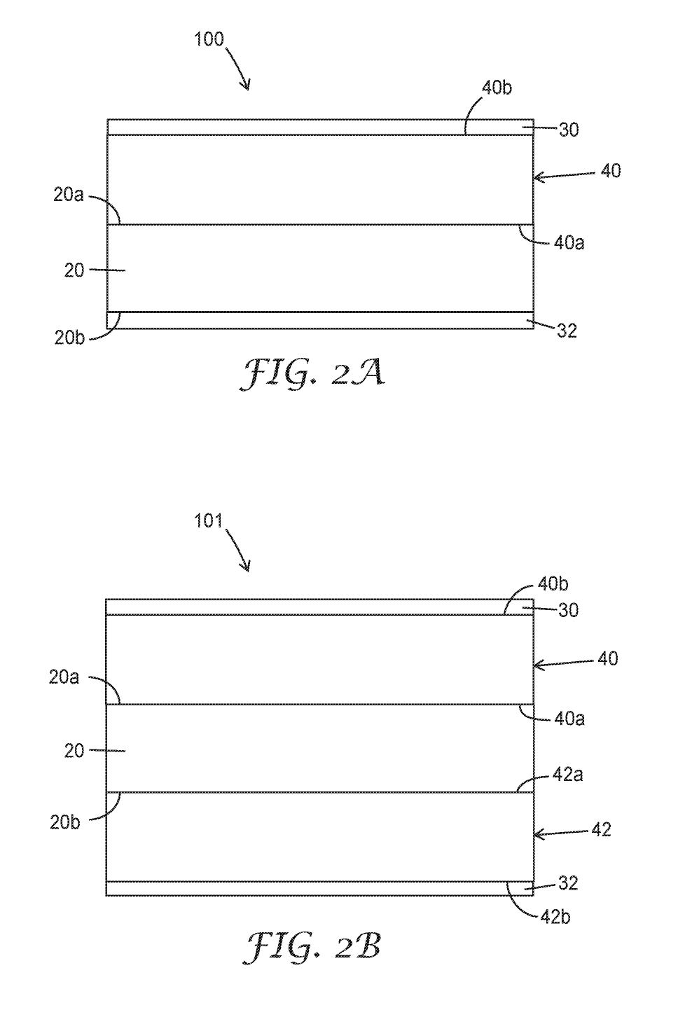

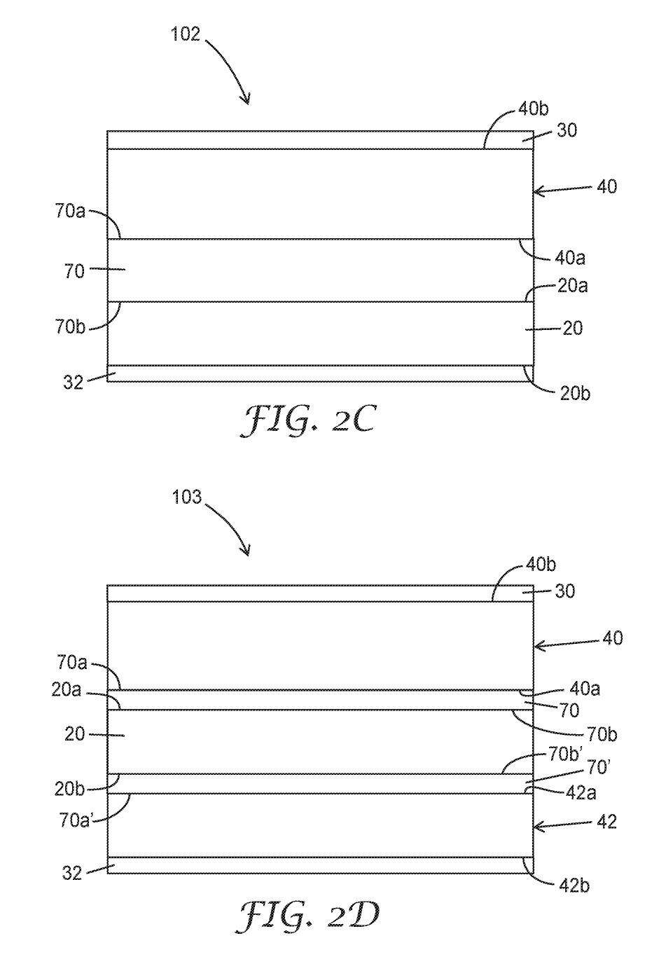

In another embodiment of the present disclosure, the porous electrodes of the present disclosure may be used to form membrane-electrode assemblies, for use in, for example, liquid flow batteries. A membrane-electrode assembly includes an ion exchange membrane, having a first surface and an opposed second surface, and a porous electrode according to any one of the embodiments of the present disclosure, wherein a major surface of the porous electrode is adjacent the first surface of the ion exchange membrane. In some embodiments a major surface of the porous electrode is proximate the first surface of the ion exchange membrane. In some embodiments a major surface of the porous electrode is in contact with the first surface of the ion exchange membrane. The membrane-electrode assembly may further include a second porous electrode, having a first major surface and a second major surface, according to any one of the porous electrodes of the present disclosure, wherein a major surface of the second porous electrode is adjacent, proximate or in contact with the opposed second surface of the ion exchange membrane. Several specific, but non-limiting, embodiments of the membrane-electrode assemblies of the present disclosure are shown in FIGS. 2A-2D.

FIG. 2A shows a schematic cross-sectional side view of a membrane-electrode assembly 100 including a first porous electrode 40 having a first major surface 40a and an opposed second major surface 40b, and a first ion exchange membrane 20 having a first major surface 20a and an opposed second major surface 20b. In some embodiments, first major surface 40a of first porous electrode 40 is proximate first surface 20a of the ion exchange membrane 20. In some embodiments, first major surface 40a of first porous electrode 40 is in contact with first major surface 20a of ion exchange membrane 20. In some embodiments, first major surface 40a of first porous electrode 40 is adjacent first major surface 20a of the ion exchange membrane 20. Electrode assembly 100 may further include one or more optional release liners 30, 32. The optional release liners 30 and 32 may remain with the membrane-electrode assembly until it is used in a cell or battery, in order to protect the outer surfaces of the ion exchange membrane and electrode from dust and debris. The release liners may also provide mechanical support and prevent tearing of the ion exchange membrane and electrode and/or marring of their surfaces, prior to fabrication of the membrane-electrode assembly. Conventional release liners known in the art may be used for optional release liners 30 and 32.

FIG. 2B shows another embodiment of a membrane-electrode assembly 101 and is similar to the membrane-electrode assembly of FIG. 2A, as previously described, and further includes a second porous electrode 42 having a first major surface 42a and an opposed second major surface 42b. In some embodiments, the first major surface 42a of second porous electrode 42 is proximate second major surface 20b of ion exchange membrane 20. In some embodiments, the first major surface 42a of second porous electrode 42 is in contact with second major surface 20b of the ion exchange membrane 20. In some embodiments, the first major surface 42a of second porous electrode 42 is adjacent second major surface 20b of the ion exchange membrane 20.

The membrane-electrode assemblies of the present disclosure include an ion exchange membrane (element 20, of FIGS. 2A and 2B). Ion exchange membranes known in the art may be used. Ion exchange membranes are often referred to as separators and may be prepared from ion exchange resins, for example, those previously discussed herein. In some embodiments, the ion exchange membranes may include a fluorinated ion exchange resin. Ion exchange membranes useful in the embodiments of the present disclosure may be fabricated from ion exchange resins known in the art or be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes and materials described in U.S. Pat. No. 7,348,088, incorporated herein by reference in its entirety. The ion exchange resins useful in the fabrication of the ion exchange membrane may be the ion exchange resin previously disclosed herein.

The ion exchange membranes of the present disclosure may be obtained as free standing films from commercial suppliers or may be fabricated by coating a solution of the appropriate ion exchange membrane resin in an appropriate solvent, and then heating to remove the solvent. The ion exchange membrane may be formed from an ion exchange membrane coating solution by coating the solution on a release liner and then drying the ion exchange membrane coating solution coating to remove the solvent. The first major surface of the resulting ion exchange membrane can then be laminated to a first major surface of a porous electrode using conventional lamination techniques, which may include at least one of pressure and heat, forming membrane-electrode assembly as shown in FIG. 2A. A first major surface 42a of a second porous electrode may then be laminated to the second major surface 20b of ion exchange membrane 20, forming a membrane-electrode assemble 101, as shown in FIG. 2B. The optional release liners 30, 32 may remain with the assembly until it is used to fabricate a membrane-electrode assembly, in order to protect the outer surface of the electrode from dust and debris. The release liners may also provide mechanical support and prevent tearing of electrode and/or marring of its surface, prior to fabrication of the membrane-electrode assembly. The ion exchange membrane coating solution may be coated directly on a surface of an electrode. The ion exchange membrane coating solution coating is then dried to form an ion exchange membrane and the corresponding membrane-electrode assembly, FIG. 2A. If a second electrode is laminated or coated on the exposed surface of the formed ion exchange membrane, a membrane-electrode assembly with two electrodes may be formed, see FIG. 2B. In another embodiment, the ion exchange membrane coating solution may be coated between two electrodes and then dried to form a membrane-electrode assembly.

Any suitable method of coating may be used to coat the ion exchange membrane coating solution on either a release liner or an electrode. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Advantageously, coating is accomplished without bleed-through of the ion exchange membrane coating from the coated side of the electrode to the uncoated side. Coating may be achieved in one pass or in multiple passes. Coating in multiple passes may be useful to increase coating weight without corresponding increases in cracking of the ion exchange membrane.

The amount of solvent, on a weight basis, in the ion exchange membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of ion exchange resin, on a weight basis, in the ion exchange membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The porous electrodes, membranes, e.g. ion exchange membranes, membrane-electrode assemblies and the electrochemical cells and liquid flow batteries of the present disclosure may include one or more microporous protection layers. Microporous protection layers are layers that may be coated or laminated on at least one of the electrode and membrane or may be place between the membrane and electrode for the purpose of preventing puncture of the membrane by the materials of the electrode. By preventing puncture of the membrane by the conductive electrode, the corresponding localized shorting of a cell or battery may be prevented. Microporous protection layers are disclosed in U.S. Provisional Patent Application Ser. No. 62/137,504, entitled “Membrane Assemblies, Electrode Assemblies, Membrane-Electrode Assemblies and Electrochemical Cells and Liquid Flow Batteries Therefrom”, which is hereby incorporated herein by reference in its entirety.

The membrane-electrode assemblies of the present disclosure may further include a microporous protection layer disposed between the porous electrode and the ion exchange membrane. In some embodiments, in membrane-electrode assemblies that include a first porous electrode and a second porous electrode, the membrane-electrode assembly may further include a first microporous protection layer disposed between the ion exchange membrane and the first porous electrode and a second microporous protection layer disposed between the ion exchange membrane and the second porous electrode. The microporous protection layer may comprise a polymer resin and an electrically conductive carbon particulate and, optionally, a non-electrically conductive particulate. The composition of the microporous protection layer differs from the composition of the porous electrodes. In some embodiments, the polymer resin of the first microporous protection layer and second microporous protection layer, if present, includes an ionic resin. Several specific, but non-limiting, embodiments of the membrane-electrode assemblies of the present disclosure are shown in FIGS. 2C and 2D.

FIG. 2C shows a schematic cross-sectional side view of membrane-electrode assembly 102 which is similar to the membrane electrode assembly of FIG. 2A, as previously described, and further includes a first microporous protection layer 70, having a first major surface 70a and a second major surface 70b, disposed between the ion exchange membrane 20 and the first porous electrode 40. The first major surface 70a of first microporous protection layer 70 may be adjacent, proximate or in contact with the first major surface 40a of first porous electrode 40. The second major 70b of first microporous protection layer 70 may be adjacent, proximate or in contact with the first major surface 20a of ion exchange membrane 20. The first microporous protection layer may comprise a polymer resin and an electrically conductive carbon particulate and, optionally, a non-electrically conductive particulate. In some embodiments, the polymer resin of the first microporous protection layer is an ionic resin.

FIG. 2D shows a schematic cross-sectional side view of membrane-electrode assembly 103 which is similar to the membrane electrode assembly of FIG. 2C, as previously described, and further includes a second microporous protection layer 70′, having a first major surface 70a′ and a second major surface 70b′, disposed between the ion exchange membrane 20 and the second porous electrode 42. The first major surface 70a′ of second microporous protection layer 70′ may be adjacent, proximate or in contact with the first major surface 42a of second porous electrode 42. The second major 70b′ of second microporous protection layer 70′ may be adjacent, proximate or in contact with the second major surface 20b of ion exchange membrane 20. The second microporous protection layer may comprise a polymer resin and an electrically conductive carbon particulate and, optionally, a non-electrically conductive particulate. In some embodiments, the polymer resin of the second microporous protection layer is an ionic resin. In some embodiments the composition of the first microporous protection layer is the same as the composition of the second microporous protection layer. In some embodiments the composition of the first microporous protection layers is different from the composition of the second microporous protection layer.

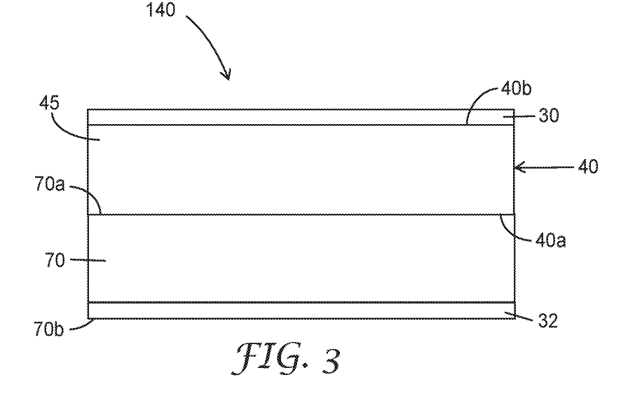

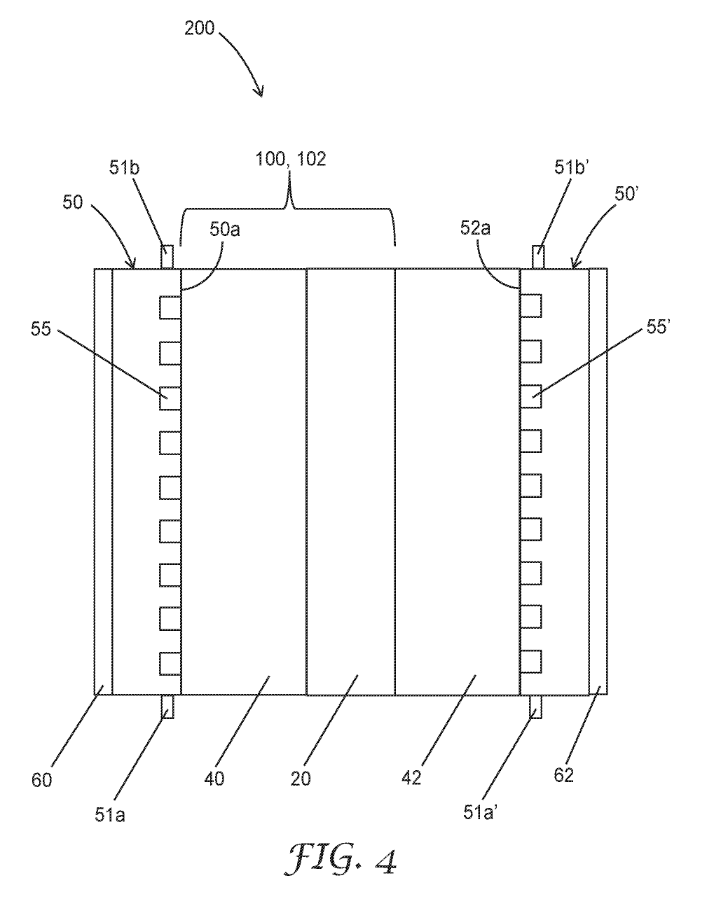

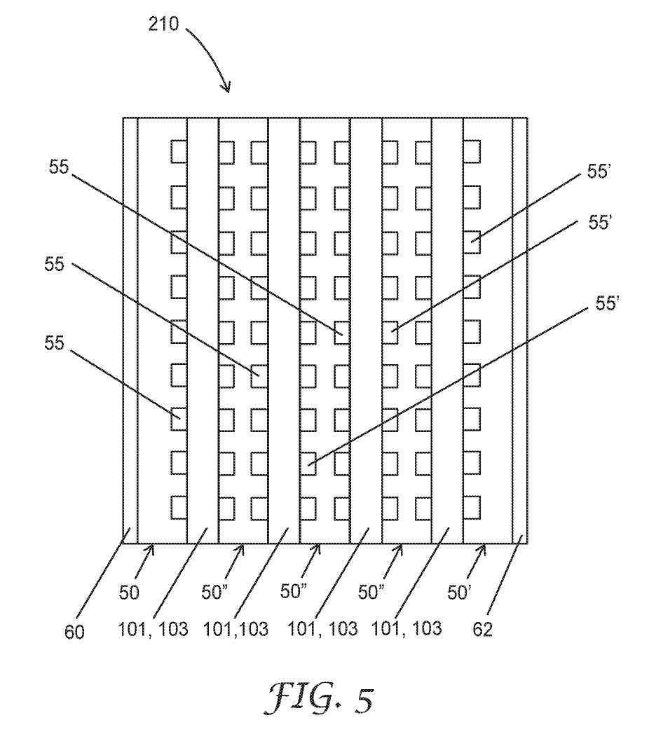

The present disclosure further provides an electrode assembly for a liquid flow battery. The electrode assembly includes a first porous electrode according to any one of the porous electrodes of the present disclosure and a first microporous protection layer. The first porous electrode includes a first major surface and an opposed second major surface, and the first microporous protection layer includes a first surface and an opposed second surface. A major surface of the first porous electrode is adjacent, proximate or in contact with the second surface of the first microporous protection layer. In some embodiments, the first major surface of the first porous electrode is adjacent, proximate or in contact with the second surface of the first microporous protection layer. In some embodiments, the second major surface of the first porous electrode is adjacent, proximate or in contact with the second surface of the first microporous protection layer. In some embodiments, the first microporous protection layer comprises a polymer resin and an electrically conductive carbon particulate and, optionally, a non-electrically conductive particulate. The composition of the microporous protection layer differs from the composition of the porous electrode. In some embodiments, the polymer resin of the first microporous protection is an ionic resin. The ionic resin may be as previously described herein. A specific, but non-limiting, embodiment of an electrode assembly of the present disclosure is shown in FIG. 3.

Referring to FIG. 3, a schematic cross-sectional side view of an exemplary electrode assembly according to one embodiment of the present disclosure, electrode assembly 140 includes a first porous electrode 40, as previously described, having a first major surface 40a and a second major surface 40b and a first microporous protection layer 70 having a first major surface 70a and an opposed second major surface 70b. In some embodiments, the first major surface 40a of the first porous electrode 40 is adjacent first major surface 70a of the first microporous protection layer 70. In some embodiments, the first major surface 40a of the first porous electrode 40 is proximate the first major surface 70a of the first microporous protection layer 70. In some embodiments, the first major surface 40a of the first porous electrode 40 is in contact with first major surface 70a of the first microporous protection layer 70. In some embodiments, the first microporous protection layer 70 comprises a polymer resin and an electrically conductive carbon particulate and, optionally, a non-electrically conductive particulate.

The electrically conductive carbon particulate of the microporous protection layer may be at least one of include particles, flakes, fibers, dendrites and the like. These particulates types have previously been defined with respect to both an electrically conductive carbon particulate and a polymer particulate and the same definition is used for electrically conductive carbon particulate of the microporous protection layer. Electrically conductive particulate of the microporous protection layers may include metals, metalized dielectrics, e.g. metalized polymer particulates or metalize glass particulates, conductive polymers and carbon, including but not limited to, glass like carbon, amorphous carbon, graphene, graphite, carbon nanotubes and carbon dendrites, e.g. branched carbon nanotubes, for example carbon nanotrees. Electrically conductive particulate of the microporous protection layer may include semi-conductor materials, e.g. BN, AlN and SiC. In some embodiments, the microporous protection layer is free of metal particulate.

In some embodiments, the electrically conductive particulate of the microporous protection layer may be surface treated to enhance the wettability of the microporous protection layer to a given anolyte or catholyte or to provide or enhance the electrochemical activity of the microporous protection layer relative to the oxidation-reduction reactions associated with the chemical composition of a given anolyte or catholyte. Surface treatments include, but are not limited to, at least one of chemical treatments, thermal treatments and plasma treatments. In some embodiments, the electrically conductive particulate of the microporous protection layer is hydrophilic.

In some embodiments, the amount of electrically conductive particulate contained in the polymer resin of the microporous protection layer, on a weight basis, may be from about 5 to about 95 percent, from about 5 to about 90 percent, from about 5 to about 80 percent, from about 5 to about 70 percent, from about 10 to about 95 percent, from about 10 to about 90 percent, from about 10 to about 80 percent, from about 10 to about 70 percent, 25 to about 95 percent, from about 25 to about 90 percent, from about 25 to about 80 percent, from about 25 to about 70 percent, from about 30 to about 95 percent, from about 30 to about 90 percent, from about 30 to about 80 percent, from about 30 to about 70 percent, 40 to about 95 percent, from about 40 to about 90 percent, from about 40 to about 80 percent, from about 40 to about 70 percent, 50 to about 95 percent, from about 50 to about 90 percent, from about 10 to about 80 percent, or even from about 50 to about 70 percent.

Non-electrically conductive particulate of the microporous protection layer include, but is not limited to non-electrically conductive inorganic particulate and non-electrically conductive polymeric particulate. In some embodiments, the non-electrically conductive particulate of the microporous protection layer comprises a non-electrically conductive inorganic particulate. Non-electrically conductive inorganic particulate include, but is not limited to, minerals and clays known in the art. In some embodiments the non-electrically conductive inorganic particulate include at least one of silica, alumina, titania, and zirconia. In some embodiments, the non-electrically conductive particulate may be ionically conductive, e.g. a polymeric ionomer. In some embodiments, the non-electrically conductive particulate comprises a non-electrically conductive polymeric particulate. In some embodiments, the non-electrically conductive polymeric particulate is a non-ionic polymer, i.e. a polymer free of repeat units having ionic functional groups. Non-electrically conductive polymers include, but are not limited to, epoxy resin, phenolic resin, polyurethanes, urea-formadehyde resin, melamine resin, polyesters, polyamides, polyethers, polycarbonates, polyimides, polysulphones, polyphenylene oxides, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the non-electrically condutcive particulate is substantially free of a non-electrically conductive polymeric particulate. By substantially free it is meant that the non-electrically conductive particulate contains, by weight, between about 0% and about 5%, between about 0% and about 3%, between about 0% and about 2%, between about 0% and about 1%, or even between about 0% and about 0.5% of a non-electrically conductive polymeric particulate.

In some embodiments, the amount of non-electrically conductive particulate contained in the polymer resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, from about 25 to about 95 percent, from about 25 to about 90 percent, from about 25 to about 80 percent, from about 25 to about 70 percent, from about 30 to 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to 99 percent, from about 50 to about 95 percent, from about 50 to about 90 percent, from about 10 to about 80 percent, or even from about 50 to about 70 percent.

In some embodiments, the amount of electrically conductive particulate and non-electrically conductive particulate, i.e. the total amount of particulate, contained in the polymer resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, 25 to about 95 percent, from about 25 to about 90 percent, from about 25 to about 80 percent, from about 25 to about 70 percent, from about 30 to about 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to about 99 percent, from about 50 to about 95 percent, from about 50 to about 90 percent, from about 50 to about 80 percent, or even from about 50 to about 70 percent.

In some embodiments, the ratio of the weight of the polymer resin of the microporous protection layer to total weight of particulate of the microporous protection layer (sum of the electrically conductive particulate and non-electrically conductive particulate) is from about 1/99 to about 10/1, from about 1/20 to about 10/1, from about 1/10 to about 10/1, from about 1/5 to about 10/1, from about 1/4 to about 10/1, from about 1/3 to about 10/1, from about 1/2 to about 10/1, from about 1/99 to about 9/1, from about 1/20 to about 9/1, from about 1/10 to about 9/1, from about 1/5 to about 9/1, from about 1/4 to about 9/1, from about 1/3 to about 9/1, from about 1/2 to about 9/1, from about 1/99 to about 8/1, from about 1/20 to about 8/1, from about 1/10 to about 8/1, from about 1/5 to about 8/1, from about 1/4 to about 8/1, from about 1/3 to about 8/1, from about 1/2 to about 8/1, from about 1/99 to about 7/1, from about 1/20 to about 7/1, from about 1/10 to about 7/1, from about 1/5 to about 7/1, from about 1/4 to about 7/1, from about 1/3 to about 7/1, from about 1/2 to about 7/1, from about 1/99 to about 6/1, from about 1/20 to about 6/1, from about 1/10 to about 6/1, from about 1/5 to about 6/1, from about 1/4 to about 6/1, from about 1/3 to about 6/1, or even from about 1/2 to about 6/1.

Microporous protection layers, electrode assemblies and methods of making them are disclosed in U.S. Provisional Patent Application Ser. No. 62/137,504, entitled “Membrane Assemblies, Electrode Assemblies, Membrane-Electrode Assemblies and Electrochemical Cells and Liquid Flow Batteries Therefrom”, which has previously been incorporated herein by reference in its entirety. Electrode assemblies may be fabricated, for example, by laminating a major surface of a previously formed porous electrode to a previously formed surface of a microporous protection layer, heat and or pressure may be used to facilitate the laminating process) or by coating at least one major surface of a porous electrode with a microporous protection layer coating, then curing and/or drying the coating to form a microporous protection layer and, subsequently, an electrode assembly.

The porous electrodes, membrane-electrode assemblies and electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, which includes at least one of an electrode or membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane-electrode assembly, i.e. laterally across the cell, shown in FIG. 4. In some embodiments, a test cell, which includes at least one of an electrode and a membrane-electrode assembly of the present disclosure may have a cell resistance of between about, 0.01 and about 10 ohm-cm², 0.01 and about 5 ohm-cm², between about 0.01 and about 1 ohm-cm², between about 0.04 and about 0.5 ohm-cm² or even between about 0.07 and about 0.1 ohm-cm².

In some embodiments of the present disclosure, the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺ vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Appl. Nos. 2014/028260, 2014/0099569, and 2014/0193687 and organic complexes, for example, U.S. Pat. Publ. No. 2014/370403 and international application published under the patent cooperation treaty Int. Publ. No. WO 2014/052682, all of which are incorporated herein by reference in their entirety.

Methods of making membrane-electrode assemblies include laminating the exposed surface of a membrane, e.g. and ion exchange membrane, to a first major surface of a porous electrode according to any one of the porous electrode embodiments of the present disclosure. This may be conducted by hand or under heat and/or pressure using conventional lamination equipment. Additionally, the membrane-electrode assembly may be formed during the fabrication of an electrochemical cell or battery. The components of the cell may be layered on top of one another in the desired order, for example, a first porous electrode, membrane, i.e. an ion exchange membrane, and a second porous electrode. The components are then assembled between, for example, the end plates of a single cell or bipolar plates of a stack having multiple cells, along with any other required gasket/sealing material. The plates, with membrane assembly there between, are then coupled together, usually by a mechanical means, e.g. bolts, clamps or the like, the plates providing a means for holding the membrane assembly together and in position within the cell. Electrode assemblies may also be formed during the fabrication of an electrochemical cell or battery, as described above, with a porous electrode and microporous protection layer included as adjacent components of the electrochemical cell or battery.

In another embodiment, the present disclosure provides an electrochemical cell including at least one porous electrode according to any one of the porous electrodes of the present disclosure. In yet another embodiment, the present disclosure provides an electrochemical cell including a membrane-electrode assembly according to any one of the membrane-electrode assembly of the present disclosure. In another embodiment, the present disclosure provides an electrochemical cell including at least one electrode assembly according to any one of the electrode assemblies of the present disclosure. FIG. 4 shows a schematic cross-sectional side view of electrochemical cell 200, which includes membrane-electrode assembly 100 or 102, end plates 50 and 50′ having fluid inlet ports, 51a and 51a′, respectively, and fluid outlet ports, 51b and 51b′, respectively, flow channels 55 and 55′, respectively, and first surface 50a and 52a, respectively. Electrochemical cell 200 also includes current collectors 60 and 62. Membrane-electrode assembly 100 or 102 is as described in FIGS. 2A and 2C, respectively (without optional release liners 30 and 32). Electrochemical cell 200 includes porous electrodes 40 and 42, and ion exchange membrane 20, all as previously described. End plates 50 and 50′ are in electrical communication with porous electrodes 40 and 42, respectively, through surfaces 50a and 52a, respectively. Porous electrode 40 may be replaced with an electrode assembly according to any one of the electrode assemblies of the present disclosure, e.g. electrode assembly 140, producing an electrochemical cell which includes an electrode assembly of the present disclosure. Second porous electrode 42 may be any one of the porous electrodes of the present disclosure or may be replace with an electrode assembly according to any one of the electrode assemblies of the present disclosure, e.g. electrode assembly 140. If an electrode assembly is used, the microporous protection layer of the electrode assembly is adjacent, proximate or in contact with the ion exchange membrane 20. Support plates, not shown, may be placed adjacent to the exterior surfaces of current collectors 60 and 62. The support plates are electrically isolated from the current collector and provide mechanical strength and support to facilitate compression of the cell assembly. End plates 50 and 50′ include fluid inlet and outlet ports and flow channels that allow anolyte and catholyte solutions to be circulated through the electrochemical cell. Assuming the anolyte is flowing through plate 50 and the catholyte is flowing through plate 50′, the flow channels 55 allow the anolyte to contact and flow into porous electrode 40, facilitating the oxidation-reduction reactions of the cell. Similarly, for the catholyte, the flow channels 55′ allow the catholyte to contact and flow into porous electrode 42, facilitating the oxidation-reduction reactions of the cell. The current collectors may be electrically connected to an external circuit.

The electrochemical cells of the present disclosure may include multiple membrane-electrode assemblies fabricated from at least one of the porous electrode embodiments of the present disclosure. In one embodiment of the present disclosure, an electrochemical cell is provided including at least two membrane-electrode assemblies, according to any one of the membrane-electrode assemblies described herein. FIG. 5 shows a schematic cross-sectional side view of electrochemical cell stack 210 including membrane-electrode assemblies 101 or 103 (as previously described), for example, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 210 includes multiple electrochemical cells, each cell represented by a membrane-electrode assembly and the corresponding adjacent bipolar plates and/or end plates. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system are not show. These features may be provided as known in the art.

The porous electrodes of the present disclosure may be used to fabricate a liquid flow battery, e.g. a redox flow battery. In one embodiment, the present disclosure provides a liquid flow battery including at least one porous electrode according to any one of the porous electrode embodiments of the present disclosure. The number of porous electrode of the liquid flow battery, which may correlate to the number of cells in a stack, is not particularly limited. In some embodiments, the liquid flow battery includes at least 1, at least 2, at least 5, at least 10 or even at least 20 porous electrodes. In some embodiments the number of porous electrodes of the liquid flow battery ranges from 1 to about 500, 2 to about 500, from 5 to about 500, from 10 to about 500 or even from 20 to about 500. In another embodiment, the present disclosure provides a liquid flow battery including at least one membrane-electrode assembly according to any one of the membrane-electrode assembly embodiments of the present disclosure. The number of membrane-electrode assemblies of the liquid flow battery, which may correlate to the number of cells in a stack, is not particularly limited. In some embodiments, the liquid flow battery includes at least 1, at least 2, at least 5, at least 10 or even at least 20 membrane-electrode assemblies. In some embodiments the number of membrane-electrode assemblies of the liquid flow battery ranges from 1 to about 500, 2 to about 500, from 5 to about 500, from 10 to about 200 or even from 20 to about 500. In yet another embodiment, the present disclosure provides a liquid flow battery including at least one electrode assembly according to any one of the electrode assembly embodiments of the present disclosure. The number of electrode assemblies of the liquid flow battery, which may correlate to the number of cells in a stack, is not particularly limited. In some embodiments, the liquid flow battery includes at least 1, at least 2, at least 5, at least 10 or even at least 20 electrode assemblies. In some embodiments the number of assemblies of the liquid flow battery ranges from 1 to about 500, 2 to about 500, from 5 to about 500, from 10 to about 500 or even from 20 to about 500.

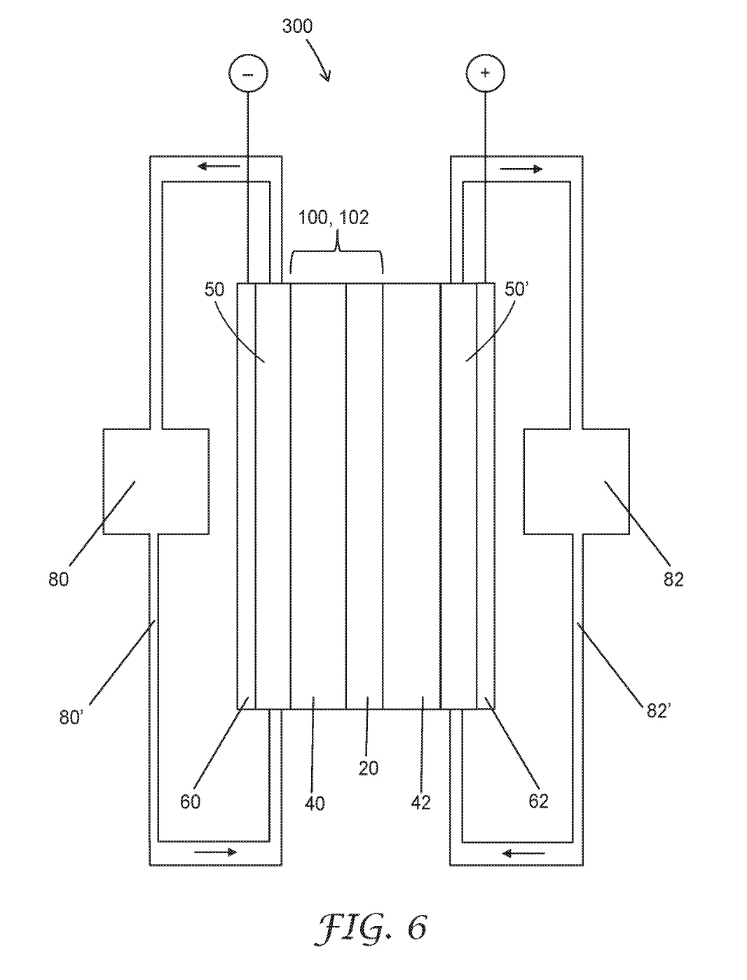

FIG. 6 shows a schematic view of an exemplary single cell, liquid flow battery 300 including membrane-electrode assembly 100 or 102, which includes ion exchange membrane 20 and porous electrodes 40 and 42, and end plates 50 and 50′, current collectors 60 and 62, anolyte reservoir 80 and anolyte fluid distribution 80′, and catholyte reservoir 82 and catholyte fluid distribution system 82′. Pumps for the fluid distribution system are not shown. First porous electrode 40 may be any one of the porous electrodes of the present disclosure or may be replace with an electrode assembly according to any one of the electrode assemblies of the present disclosure, e.g. electrode assembly 140, producing a liquid flow battery which includes an electrode assembly of the present disclosure. Second porous electrode 42 may be any one of the porous electrodes of the present disclosure or may be replace with an electrode assembly according to any one of the electrode assemblies of the present disclosure, e.g. electrode assembly 140, producing a liquid flow battery which includes an electrode assembly of the present disclosure. If an electrode assembly is used, the microporous protection layer of the electrode assembly is adjacent, proximate or in contact with the ion exchange membrane 20. Current collectors 60 and 62 may be connected to an external circuit which includes an electrical load (not shown). Although a single cell liquid flow battery is shown, it is known in the art that liquid flow batteries may contain multiple electrochemical cells, i.e. a cell stack. Further multiple cell stacks may be used to form a liquid flow battery, e. g. multiple cell stacks connected in series. The porous electrodes, the ion exchange membranes, and their corresponding membrane-electrode assemblies of the present disclosure may be used to fabricate liquid flow batteries having multiple cells, for example, multiple cell stack of FIG. 5. Flow fields may be present, but this is not a requirement.

Select embodiments of the present disclosure include, but are not limited to, the following:

In a first embodiment, the present disclosure provides a membrane-electrode assembly for a liquid flow battery comprising: an ion exchange membrane having a first surface and an opposed second surface; and a first porous electrode, having a first major surface and a second major surface, comprising:

non-electrically conductive, polymer particulate fibers in the form of a first porous substrate, wherein the first porous substrate is at least one of a woven or nonwoven paper, felt, mat and cloth; and

electrically conductive carbon particulate embedded in the pores of the first porous substrate and adhered directly to the surface of the non-electrically conductive, polymer particulate fibers of the first porous substrate; and wherein the first major surface of the first porous electrode is proximate to the first surface of the ion exchange membrane.

In a second embodiment, the present disclosure provides a membrane-electrode assembly for a liquid flow battery according to the first embodiment, wherein the electrically conductive carbon particulate of the first porous electrode is at least one of carbon particles, carbon flakes, carbon fibers, carbon dendrites, carbon nanotubes and branched carbon nanotubes.

In a third embodiment, the present disclosure provides a membrane-electrode assembly for a liquid flow battery according to the first embodiment, wherein the electrically conductive carbon particulate of the first porous electrode is at least one of carbon nanotubes and branched carbon nanotubes.

In a fourth embodiment, the present disclosure provides a membrane-electrode assembly for a liquid flow battery according to the first embodiment, wherein the electrically conductive carbon particulate of the first porous electrode is at least one of carbon particles, carbon flakes and carbon dendrites.

In a fifth embodiment, the present disclosure provides a membrane-electrode assembly for a liquid flow battery according to the first embodiment, wherein the electrically conductive carbon particulate of the first porous electrode is at least one of graphite particles, graphite flakes, graphite fibers and graphite dendrites.

In a sixth embodiment, the present disclosure provides a membrane-electrode assembly for a liquid flow battery according to any one of the first through fifth embodiments, wherein at least a portion of the non-electrically conductive polymer particulate fibers of the first porous substrate has a core-shell structure, wherein the core-shell structure includes an inner core comprising a first polymer and an outer shell comprising a second polymer.

In a seventh embodiment, the present disclosure provides a membrane-electrode assembly for a liquid flow battery according to the sixth embodiment, wherein the second polymer has a softening temperature that is lower than softening temperature of the first polymer.

In an eighth embodiment, the present disclosure provides a membrane-electrode assembly for a liquid flow battery according to any one of the first through seventh embodiments, wherein the amount of electrically conductive carbon particulate contained in the first porous electrode is from about 5 to about 99 percent by weight.

In a ninth embodiment, the present disclosure provides a membrane-electrode assembly for a liquid flow battery according to any one of the first through seventh embodiments, wherein the amount of electrically conductive carbon particulate contained in the first porous electrode is from about 40 to about 80 percent by weight.

In a tenth embodiment, the present disclosure provides a membrane-electrode assembly for a liquid flow battery according to any one of the first through ninth embodiments, wherein the first porous electrode has a thickness from about 10 microns to about 1000 microns.

In an eleventh embodiment, the present disclosure provides a membrane-electrode assembly for a liquid flow battery according to any one of the first through tenth embodiments, wherein the first porous electrode has an electrical resistivity of less than about 100000 μOhm·m.

In a twelfth embodiment, the present disclosure provides a membrane-electrode assembly for a liquid flow battery according to any one of the first through eleventh embodiments, wherein the electrically conductive carbon particulate of the first porous electrode has enhanced electrochemical activity, produced by at least one of chemical treatment, thermal treatment and plasma treatment.

In a thirteenth embodiment, the present disclosure provides a membrane-electrode assembly for a liquid flow battery according to any one of the first through twelfth embodiments, further comprising a second porous electrode, having a first major surface and a second major surface, comprising:

non-electrically conductive polymer particulate fibers in the form of a second porous substrate, wherein the second porous substrate is at least one of a woven or nonwoven paper, felt, mat and cloth; and

electrically conductive carbon particulate embedded in the pores of the second porous substrate and adhered directly to the surface of the non-electrically conductive, polymer particulate fibers of the second porous substrate; and wherein the first major surface of the second porous electrode is proximate to the second surface of the ion exchange membrane.

In a fourteenth embodiment, the present disclosure provides a membrane-electrode assembly for a liquid flow battery according to the thirteenth embodiment, wherein the electrically conductive carbon particulate of the second porous electrode is at least one of carbon particles, carbon flakes, carbon fibers, carbon dendrites, carbon nanotubes and branched carbon nanotubes.

In a fifteenth embodiment, the present disclosure provides a membrane-electrode assembly for a liquid flow battery according to the thirteenth embodiment, wherein the electrically conductive carbon particulate of the second porous electrode is at least one of carbon nanotubes and branched carbon nanotubes.

In a sixteenth embodiment, the present disclosure provides a membrane-electrode assembly for a liquid flow battery according to the thirteenth embodiment, wherein the electrically conductive carbon particulate of the second porous electrode is at least one of carbon particles, carbon flakes and carbon dendrites.

In a seventeenth embodiment, the present disclosure provides a membrane-electrode assembly for a liquid flow battery according to the thirteenth embodiment, wherein the electrically conductive carbon particulate of the second porous electrode is at least one of graphite particles, graphite flakes, graphite fibers and graphite dendrites.

In an eighteenth embodiment, the present disclosure provides a membrane-electrode assembly for a liquid flow battery according to any one of the thirteenth through seventeenth embodiments, wherein at least a portion of the non-electrically conductive polymer particulate fibers of the second porous substrate has a core-shell structure, wherein the core-shell structure includes an inner core comprising a third polymer and an outer shell comprising a fourth polymer.

In a nineteenth embodiment, the present disclosure provides a membrane-electrode assembly for a liquid flow battery according to the eighteenth embodiment, wherein the fourth polymer has a softening temperature that is lower than softening temperature of the third polymer.

In a twentieth embodiment, the present disclosure provides a membrane-electrode assembly for a liquid flow battery according to any one of the thirteenth through nineteenth embodiments, wherein the amount of electrically conductive carbon particulate contained in the second porous electrode is from about 5 to about 99 percent by weight.

In a twenty-first embodiment, the present disclosure provides a membrane-electrode assembly for a liquid flow battery according to any one of the thirteenth through nineteenth embodiments, wherein the amount of electrically conductive carbon particulate contained in the second porous electrode is from about 40 to about 80 percent by weight.

In a twenty-second embodiment, the present disclosure provides a membrane-electrode assembly for a liquid flow battery according to any one of the thirteenth through twenty-first embodiments, wherein the second porous electrode has a thickness from about 10 microns to about 1000 microns.

In a twenty-third embodiment, the present disclosure provides a membrane-electrode assembly for a liquid flow battery according to any one of the thirteenth through twenty-second embodiments, wherein the second porous electrode has an electrical resistivity of less than about 100000 μOhm·m.

In a twenty-fourth embodiment, the present disclosure provides a membrane-electrode assembly for a liquid flow battery according to any one of the thirteenth through twenty-third embodiments, wherein the electrically conductive carbon particulate of the second porous electrode has enhanced electrochemical activity, produced by at least one of chemical treatment, thermal treatment and plasma treatment.

In a twenty-fifth embodiment, the present disclosure provides a membrane-electrode assembly for a liquid flow battery according to any one of the first through twenty-fourth embodiments, further comprising a first microporous protection layer disposed between the ion exchange membrane and the first porous electrode, wherein the first microporous protection layer comprises a polymer resin and an electrically conductive carbon particulate and, optionally, a non-electrically conductive particulate.

In a twenty-sixth embodiment, the present disclosure provides a membrane-electrode assembly for a liquid flow battery according to any one of the thirteenth through twenty-fourth embodiments, further comprising a first microporous protection layer disposed between the ion exchange membrane and the first porous electrode and a second microporous protection layer disposed between the ion exchange membrane and the second porous electrode, wherein the first and second microporous protection layers each comprise a polymer resin and an electrically conductive carbon particulate and, optionally, a non-electrically conductive particulate.

In a twenty-seventh embodiment, the present disclosure provides a membrane-electrode assembly for a liquid flow battery according to the twenty-fifth or twenty-sixth embodiments, wherein the polymer resin of the first microporous protection layer and second microporous protection layer, if a second microporous protection layer is present, is an ionic resin.

In a twenty-eighth embodiment, the present disclosure provides an electrode assembly for a liquid flow battery comprising:

a first porous electrode, having a first major surface and a second major surface, comprising:

non-electrically conductive polymer particulate fibers in the form of a first porous substrate, wherein the first porous substrate is at least one of a woven or nonwoven paper, felt, mat and cloth; and

electrically conductive carbon particulate embedded in the pores of the first porous substrate and adhered directly to the surface of the non-electrically conductive, polymer particulate fibers of the first porous substrate; and

a first microporous protection layer having a first surface and an opposed second surface; and wherein the first major surface of the first porous electrode is proximate the first major surface of the first microporous protection layer, and wherein the first microporous protection layer comprises a polymer resin and an electrically conductive carbon particulate and, optionally, a non-electrically conductive particulate.

In a twenty-ninth embodiment, the present disclosure provides an electrode assembly for a liquid flow battery according to the twenty-eighth embodiment, wherein the electrically conductive carbon particulate of the first porous electrode is at least one of carbon particles, carbon flakes, carbon fibers, carbon dendrites, carbon nanotubes and branched carbon nanotubes.

In a thirtieth embodiment, the present disclosure provides an electrode assembly for a liquid flow battery according to the twenty-eighth embodiment, wherein the electrically conductive carbon particulate of the first porous electrode is at least one of carbon nanotubes and branched carbon nanotubes.

In a thirty-first embodiment, the present disclosure provides an electrode assembly for a liquid flow battery according to the twenty-eighth embodiment, wherein the electrically conductive carbon particulate of the first porous electrode is at least one of carbon particles, carbon flakes and carbon dendrites.

In a thirty-second embodiment, the present disclosure provides an electrode assembly for a liquid flow battery according to the twenty-eighth embodiment, wherein the electrically conductive carbon particulate of the first porous electrode is at least one of graphite particles, graphite flakes, graphite fibers and graphite dendrites.

In a thirty-third embodiment, the present disclosure provides an electrode assembly for a liquid flow battery according to any one of the twenty-eighth through thirty-second embodiments, wherein the polymer resin of the first microporous protection is an ionic resin.

In a thirty-fourth embodiment, the present disclosure provides an electrode assembly for a liquid flow battery according to any one of the twenty-eighth through thirty-third embodiments, wherein at least a portion of the non-electrically conductive polymer particulate fibers of the first porous substrate has a core-shell structure, wherein the core-shell structure includes an inner core comprising a first polymer and an outer shell comprising a second polymer.

In a thirty-fifth embodiment, the present disclosure provides an electrode assembly for a liquid flow battery according to the thirty-fourth embodiment, wherein the second polymer has a softening temperature that is lower than softening temperature of the first polymer.

In a thirty-sixth embodiment, the present disclosure provides an electrode assembly for a liquid flow battery according to any one of the twenty-eighth through thirty-fifth embodiments, wherein the amount of electrically conductive carbon particulate contained in the first porous electrode is from about 5 to about 99 percent by weight.

In a thirty-seventh embodiment, the present disclosure provides an electrode assembly for a liquid flow battery according to any one of the twenty-eighth through thirty-fifth embodiments, wherein the amount of electrically conductive carbon particulate contained in the first porous electrode is from about 40 to about 80 percent by weight.

In a thirty-eighth embodiment, the present disclosure provides an electrode assembly for a liquid flow battery according to any one of the twenty-eighth through thirty-seventh embodiments, wherein the first porous electrode has a thickness from about 10 microns to about 1000 microns.

In a thirty-ninth embodiment, the present disclosure provides an electrode assembly for a liquid flow battery according to any one of the twenty-eighth through thirty-eighth embodiments, wherein the first porous electrode has an electrical resistivity of less than about 100000 μOhm·m. In a fortieth embodiment, the present disclosure provides an electrode assembly for a liquid flow battery according to any one of the twenty-eighth through thirty-ninth embodiments, wherein the electrically conductive carbon particulate of the first porous electrode has enhanced electrochemical activity, produced by at least one of chemical treatment, thermal treatment and plasma treatment.

In a forty-first embodiment, the present disclosure provides an electrochemical cell for a liquid flow battery comprising a membrane-electrode assembly according to any one of the first through twenty-seventh embodiments.

In a forty-second embodiment, the present disclosure provides an electrochemical cell for a liquid flow battery comprising at least one electrode assembly according to any one of the twenty-eighth through fortieth embodiments.

In a forty-third embodiment, the present disclosure provides a liquid flow battery comprising at least one membrane-electrode assembly according to any one of the first through twenty-seventh embodiments.

In a forty-fourth embodiment, the present disclosure provides a liquid flow battery comprising at least one electrode assembly according to any one of the twenty-eighth through fortieth embodiments.

### EXAMPLES

### Electrical Resistivity Test Method

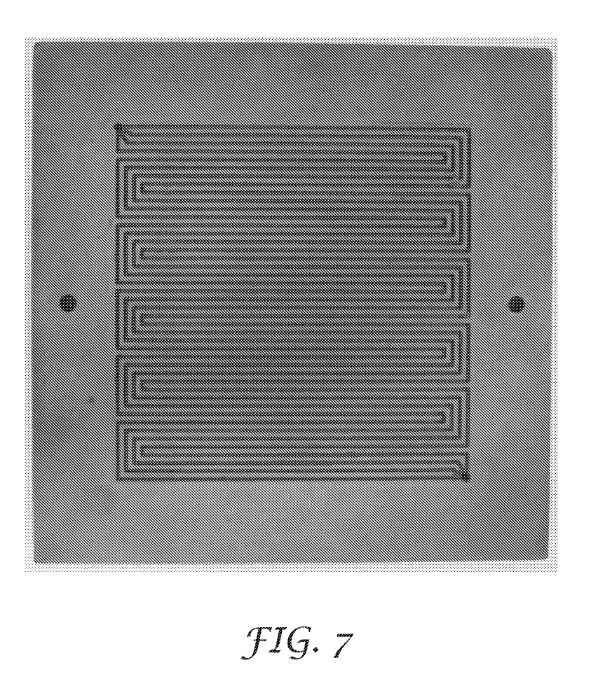

Electrode samples were cut into 7 cm×7 cm squares for conductivity testing. A sample was placed between two graphite plates, each having four, serpentine flow channels. The flow channels had a depth of about 1.0 mm, a width of about 0.78 mm, a pitch (center to center distance between adjacent channels) of about 1.58 mm and the overall area covered by the serpentine flow channels was a square having dimensions of about 6.9 cm×about 6.9 cm (see FIG. 7). Along with the electrode sample, gaskets, were placed between and along the outer perimeter of the plates (around the electrode). The thickness of the gaskets were selected to achieve the desired compression, based on the thickness of the original porous electrode (Table 1). The electrode sample was aligned with and contacted the square region of the serpentine flow channels of both plates. The plates were compressed, until the surface of both plates contacted the gaskets, yielding a compression in the thickness of the electrode as indicated in Table 1. Using a power supply available under the trade designation ZUP 10-40, from TDK-Lambda, Tokyo, Japan, a constant 35 A current was applied across the sample, and the voltage between the two plates was measured using a digital multi-meter available under the trade designation 197 A AUTORANGING MICROVOLT DMM from KEITHLEY, Cleveland, Ohio. Based on the voltage drop across the sample, the resistivity of the sample was calculated and reported.

Resistivity=R(A/L)

where,

R is the electrical resistance of the material, measure in ohms, for example,

A is the cross-sectional area of the electrode, measured in square meters, for example,

L is the length of the electrode, measured in meters, for example.

### Preparation of a Porous Substrate in the Form of a Nonwoven Mat

Non-electrically conductive, polymer particulate fibers, four denier, bicomponent, staple fibersat 50 mm cut length, 6.5 crimp/25.4 lineal mm, 0.2% finish, available under the trade name, TAIRILIN L41 131-00451N2A from Stein Fibers, Ltd., Albany N.Y., were pre-opened and then used as input to form a fibrous layer. These fibers are of the core-sheath type. The pre-opened fibers (100% TAIRILIN L41) were not blended before they were fed into a conventional web-forming machine (commercially available under the trade designation “RANDO WEBBER” from Rando Machine Corporation, Macedon, N.Y.) wherein the fibers are drawn onto the condensor. Conditions were adjusted to form a fibrous layer having a 60 grams per square meter basis weight and an average thickness of 4 mm.

The 60 grams per square meter fibrous layer had sufficient handling strength to be transferred to a needle punch machine without the need for a support (e.g., a scrim). A conventional needle punching apparatus (commercially available under the trade designation “DILO” from Dilo Group, Eberbach, Germany), with barbed needles (available from Foster Needle Company, Inc., Manitowoc, Wis.) was used to compress the fibrous layer by punching and drawing the barbed needles through the fibrous layer, thereby forming a porous substrate in the form of a nonwoven mat from the non-electrically conductive, polymer particulate fibers.

This needle punch operation was the preferred approach to increase the strength of the fibrous layer, as it did not require heat activation of the lower melting fiber component (sheath) in the bicomponent staple fibers. Thus, the lower melting sheath component would be available to provide better adhesion for the electrically conductive carbon particulate, during its subsequent coating and heat compression steps (described below). However heating the fibrous layer to activate the low melting component by use of an oven, a heat source, calendar or other approach known to those skilled in the art could also have been used to increase the strength.

The nonwoven mat was then embedded with electrically conductive carbon particulate, in this case graphite particulate, by the following procedure.

### Example 1a

A 7.5 cm×10 cm sample of the nonwoven mat was cut out and secured to the bottom of an aluminum (Al) pan with SCOTCH double sided tape. 1.5 gm of synthetic graphite powder available under the product number 28,286-3 from Sigma-Aldrich Co, St. Louis, Mo. The graphite powder was heat treated at 400° C. for 40 hours in air and, after cooling, was poured on top of the nonwoven mat. Next, 6.35 mm diameter chrome steel balls (from Royal Steel Ball Products, Inc., Sterling, Ill.) was poured over the top of the graphite and nonwoven mat until the media had three layers of balls. The pan was then hermetically sealed by taping a film over the top of the pan. The pan was then placed on an orbital shaker table and shaken for 24 hours at approximately 180 rpm, to embed the graphite particulate into the pores of the nonwoven mat. The nonwoven mat with graphite particulate was then removed from the Al pan and placed between two Al plates, and the plates with nonwoven were placed in an oven and heated at 150° C. for 30 minutes. The Al plate on the top surface of the nonwoven mat had a mass of 3840 grams. After this heating/compressing step, the nonwoven mat was removed from the oven and allowed to cool while between the Al plates, forming a porous electrode of the present disclosure, Example 1a. The density of Example 1a was about 0.44 g/cm³.

### Example 1b

A 7.5 cm×10 cm sample of the nonwoven mat was cut out and placed in a plastic bag. 1.5 gm of synthetic graphite powder available under the product number 28,286-3 from Sigma-Aldrich Co, St. Louis, Mo., was poured into the bag with the nonwoven matt and the bag was closed and sealed. The bag was shaken by hand to embed the graphite particulate into the pores of the nonwoven mat, until the nonwoven web look visually uniform. The nonwoven mat with embedded graphite particulate was then removed from the bag and placed between two Al plates and heated at 150° C. for 30 minutes. The Al plate on the top surface of the nonwoven mat had a mass of 3840 grams. After this heating/compressing step the sample was removed and allowed to cool while between the Al plates, forming a porous electrode of the present disclosure, Example 1b. The density of Example 1b was about 0.44 g/cm³.

### Example 2

Example 2 was an activated carbon web which was produced in accordance with example 1a of U.S. Pat. Publ. No. 2013/0037481 A1, where the sample has an average basis weight of 1000 g/m2, with a 9 to 1 weight ratio between activated carbon of the type 30×60 CTC 60 (commercially available from Kuraray Chemicals Co., Ltd. Osaka, Japan), and bicomponent fiber of the type TREVIRA T255 (commercially available from Trevira GmbH, Bobingen, Germany) having 1.3 denier and 6 mm length. The density of Example 2 was 0.18 g/cm³.

### Comparative Example 3 (CE-3)

CE-3 was a graphite paper available under the trade designation SIGRACET GDL 39AA from SGL Carbon GmbH, Wiesbaden, Germany. SIGRACET GDL 39AA was heat treated in a furnace at 425° Celcius for 24 hours, prior to electrical resistivity testing. The density of CE-3 was 0.19 g/cm³.

Examples 1a and 1b, Example 2 and CE-3 were tested for electrical resistivity using the Electrical Resistivity Test Method, described above. Results of this testing are shown in Table 1.

TABLE 1

| | Mean | Compressed | | |
|---|---|---|---|---|
| | Thickness | Thickness | | Resistivity |
| Example | (mm) | (mm) | Compression | [μOhm · m] |
| 1a | 0.595 | 0.201 | 66.2% | 11000 |
| 1b | 0.404 | 0.152 | 62.3% | 13000 |
| 2 | 5.65 | 2.23 | 60.5% | 194000 |
| CE-3 | 0.266 | 0.132 | 50.3% | 7000 |

### Example 4

A porous electrode was prepared similarly to Example 1a, except that, in the preparation of the nonwoven mat, the process conditions were adjusted to produce a nonwoven mat having a basis weight of 135 gm/cm². The porous electrode of Example 4 had an average thickness of 0.836 mm

### Example 5

A membrane electrode assembly (MEA) was prepared with the electrode of Example 4 by laminating a 5 mm wide frame of an adhesive, available under the trade designation 3M OPTICALLY CLEAR ADHESIVE 8146-4, from 3M Company (St Paul, Minn.), to a 6 cm×10 cm piece of the electrode of Example 4. A 6 cm×10 cm piece of perfluorinated membrane, available under the trade designation NAFION 112 (from DuPont Fuel Cells, Wilmington, Del.) was then hand laminated to the electrode, via the exposed surface of the adhesive, to produce the MEA of Example 5.

### Example 6

To simulate the use in a redox flow battery the following half-cell apparatus was used to generate a current.

### Electrochemical Cell Hardware:

The hardware used was a modified fuel cell test fixture, model number 5SCH (available from Fuel Cell Technologies, Albuquerque, N. Mex.), that utilizes two graphite bi-polar plates, two gold plated copper current collectors and aluminum end plates. The graphite bi-polar plates had a 5 cm² single serpentine channel with an entry port on top and exit port on the bottom.

### Electrochemical Cell Assembly:

The test cell was assembled by placing on one graphite plate a 20.8 mil (0.528 mm) thick piece of gasket material that had a 5 cm² area removed from the center. A piece of electrode material of Example 1b was cut to the appropriate size and placed into the 5 cm² area cavity. A 50 micron thick proton exchange membrane, designated as 800EW 3M membrane (800 equivalent weight proton exchange membrane prepared by following the membrane preparation procedure described in the EXAMPLE section of U.S. Pat. No. 7,348,088, which is incorporated herein by reference in its entirety), was placed over the electrode/gasket assembly. Next another piece of 20.8 (0.528 mm) mil gasket material with an open cavity was placed onto of the membrane and a second piece of electrode material from Example 1b was placed in the cavity of the gasket material. The second graphite plate was placed onto of the stacked components to complete the test cell. The test cell was then placed between two aluminum end plates with current collectors and secured with a series of 8 bolts that were tightened to 120 in·lbs (13.6 N·m).

### Electrochemical Cell Operation:

The entry and exit ports of the test cell were connected to tubing that delivered an electrolyte, 2.7 M H₂SO₄/1.5 M VOSO₄ electrolyte (H₂SO₄ and VOSO₄ were from Sigma Aldrich, St. Louis, Mo.), using a diaphragm pump (model NF B 5 diaphragm pump from KNF Neuberger GmbH, Frieburg, Germany), at a flow rate of 54.6 ml/min. Prior to testing, the electrolyte had been electrochemically oxidized to the V⁺⁵ valence state. This was accomplished by circulating the electrolyte with the described pump and applying an oxidizing current at a rate of 80 mA/cm² until the system reached 1.8V. The system was then held at 1.8V until the current generated decayed to a value of 5 mA/cm². Once oxidized, the prepared electrolyte was used for testing. The tubing was connected such that the electrolyte was pumped from an electrolyte storage vessel into the top port of one of the bipolar plates (first bipolar plate) through the test cell and then exited the bottom port of the bipolar plate. The electrolyte exiting the bottom port of the first bipolar plate was then fed into the bottom port of the second bipolar plate, passed through the test cell, and exited the top port of the second bipolar plate and returned to the electrolyte storage vessel. This system used a single electrolyte operating in a counter-flow mode, where in one half-cell the V⁺⁵ molecule is reduced to V⁺⁴ and in the other half-cell it was subsequently oxidized to V⁺⁵.

### Electrochemical Cell Testing:

The electrochemical cell was connected to a Biologic MPG-205 potentio/galvanostat (available from Bio-Logic Science Instruments, Claix, France) with one current collector serving as the anode and the other current collector serving as the cathode. The electrochemical testing procedure was as follows.
1) Insure that electrolyte is flowing through the cell.
2) Monitor the open circuit voltage (OCV) for 180 seconds
3) Apply a 10 mV signal over the system voltage to the cell using frequencies from 20 kHz to 10 mHz and record the resulting currents.
4) Apply a 50 mV reducing potential (versus OCV) to the system for 180 seconds and record the generated current.
5) Repeat steps 3 and 4 in 50 mV increments ranging from 50 mV to 300 mV versus open circuit voltage (OCV).
   Using this test procedure, the current density as a function of polarization voltage was determined for the porous electrode of Example 1b. Results are shown in Table 2.

TABLE 2

| Polarization Voltage | Current Density |
|---|---|
| verses OCV (mV) | (mA/cm²) |
| 50 | 20.2 |
| 100 | 36.3 |
| 150 | 48.2 |
| 200 | 57.3 |
| 250 | 65.3 |
| 300 | 72.6 |

1) A membrane-electrode assembly for a liquid flow battery comprising:
an ion exchange membrane having a first surface and an opposed second surface; and
a first porous electrode, having a first major surface and a second major surface, comprising:
non-electrically conductive, polymer particulate fibers in the form of a first porous substrate, wherein the first porous substrate is at least one of a woven or nonwoven paper, felt, mat and cloth; and
electrically conductive carbon particulate embedded in the pores of the first porous substrate and adhered directly to the surface of the non-electrically conductive, polymer particulate fibers of the first porous substrate; and
wherein the first major surface of the first porous electrode is proximate to the first surface of the ion exchange membrane.

2) The membrane-electrode assembly for a liquid flow battery of claim 1, wherein the electrically conductive carbon particulate of the first porous electrode is at least one of carbon particles, carbon flakes, carbon fibers, carbon dendrites, carbon nanotubes and branched carbon nanotubes.

3) The membrane-electrode assembly for a liquid flow battery of claim 1, wherein the electrically conductive carbon particulate of the first porous electrode is at least one of carbon nanotubes and branched carbon nanotubes.

4) (canceled)

5) The membrane-electrode assembly for a liquid flow battery of claim 1, wherein the electrically conductive carbon particulate of the first porous electrode is at least one of graphite particles, graphite flakes, graphite fibers and graphite dendrites.

6) The membrane-electrode assembly for a liquid flow battery of claim 1, wherein at least a portion of the non-electrically conductive polymer particulate fibers of the first porous substrate has a core-shell structure, wherein the core-shell structure includes an inner core comprising a first polymer and an outer shell comprising a second polymer.

7) The membrane-electrode assembly for a liquid flow battery of claim 6, wherein the second polymer has a softening temperature that is lower than softening temperature of the first polymer.

8) (canceled)

9) The membrane-electrode assembly for a liquid flow battery of claim 1, wherein the amount of electrically conductive carbon particulate contained in the first porous electrode is from about 40 to about 80 percent by weight.

10) (canceled)

11) (canceled)

12) The membrane-electrode assembly for a liquid flow battery of claim 1, wherein the electrically conductive carbon particulate of the first porous electrode has enhanced electrochemical activity, produced by at least one of chemical treatment, thermal treatment and plasma treatment.

13) The membrane-electrode assembly for a liquid flow battery of claim 1 further comprising a second porous electrode, having a first major surface and a second major surface, comprising:
non-electrically conductive polymer particulate fibers in the form of a second porous substrate, wherein the second porous substrate is at least one of a woven or nonwoven paper, felt, mat and cloth; and
electrically conductive carbon particulate embedded in the pores of the second porous substrate and adhered directly to the surface of the non-electrically conductive, polymer particulate fibers of the second porous substrate; and wherein the first major surface of the second porous electrode is proximate to the second surface of the ion exchange membrane.

14) The membrane-electrode assembly for a liquid flow battery of claim 13, wherein the electrically conductive carbon particulate of the second porous electrode is at least one of carbon particles, carbon flakes, carbon fibers, carbon dendrites, carbon nanotubes and branched carbon nanotubes.

15) (canceled)

16) (canceled)

17) The membrane-electrode assembly for a liquid flow battery of claim 13, wherein the electrically conductive carbon particulate of the second porous electrode is at least one of graphite particles, graphite flakes, graphite fibers and graphite dendrites.

18) The membrane-electrode assembly for a liquid flow battery of claim 13, wherein at least a portion of the non-electrically conductive polymer particulate fibers of the second porous substrate has a core-shell structure, wherein the core-shell structure includes an inner core comprising a third polymer and an outer shell comprising a fourth polymer.

19) The membrane-electrode assembly for a liquid flow battery of claim 18, wherein the fourth polymer has a softening temperature that is lower than softening temperature of the third polymer.

20) The membrane-electrode assembly for a liquid flow battery of claim 13, wherein the amount of electrically conductive carbon particulate contained in the second porous electrode is from about 5 to about 99 percent by weight.

21) The membrane-electrode assembly for a liquid flow battery of claim 13, wherein the amount of electrically conductive carbon particulate contained in the second porous electrode is from about 40 to about 80 percent by weight.

22) The membrane-electrode assembly for a liquid flow battery of claim 13, wherein the second porous electrode has a thickness from about 10 microns to about 1000 microns.

23) The membrane-electrode assembly for a liquid flow battery of claim 13, wherein the second porous electrode has an electrical resistivity of less than about 100000 μOhm·m.

24) (canceled)

25) The membrane-electrode assembly for a liquid flow battery of claim 1 further comprising a first microporous protection layer disposed between the ion exchange membrane and the first porous electrode, wherein the first microporous protection layer comprises a polymer resin and an electrically conductive carbon.

26) (canceled)

27) (canceled)

28) An electrode assembly for a liquid flow battery comprising:
a first porous electrode, having a first major surface and a second major surface, comprising:
non-electrically conductive polymer particulate fibers in the form of a first porous substrate, wherein the first porous substrate is at least one of a woven or nonwoven paper, felt, mat and cloth; and
electrically conductive carbon particulate embedded in the pores of the first porous substrate and adhered directly to the surface of the non-electrically conductive, polymer particulate fibers of the first porous substrate; and
a first microporous protection layer having a first surface and an opposed second surface; and
wherein the first major surface of the first porous electrode is proximate the first major surface of the first microporous protection layer, and wherein the first microporous protection layer comprises a polymer resin and an electrically conductive carbon particulate.

29) (canceled)

30) (canceled)

31) (canceled)

32) (canceled)

33) The electrode assembly for a liquid flow battery of claim 28, wherein the polymer resin of the first microporous protection is an ionic resin.

34) The electrode assembly for a liquid flow battery of claim 28, wherein at least a portion of the non-electrically conductive polymer particulate fibers of the first porous substrate has a core-shell structure, wherein the core-shell structure includes an inner core comprising a first polymer and an outer shell comprising a second polymer, and wherein the second polymer has a softening temperature that is lower than softening temperature of the first polymer.

35) (canceled)

36) (canceled)

37) The electrode assembly for a liquid flow battery of claim 28, wherein the amount of electrically conductive carbon particulate contained in the first porous electrode is from about 40 to about 80 percent by weight.

38) The electrode assembly for a liquid flow battery of claim 28, wherein the first porous electrode has a thickness from about 10 microns to about 1000 microns.

39) (canceled)

40) (canceled)

41) An electrochemical cell for a liquid flow battery comprising a membrane-electrode assembly according to claim 1.

42) An electrochemical cell for a liquid flow battery comprising at least one electrode assembly according to claim 28.

43) A liquid flow battery comprising at least one membrane-electrode assembly according to claim 1.

44) A liquid flow battery comprising at least one electrode assembly according to claim 28.
